(19) United States
(12) Patent Application Publication
(10) Pub. No.: US 2014/0113224 A1
(43) Pub. Date: Apr. 24, 2014

(54) METHOD FOR FORMING ELECTROPHOTOGRAPHIC IMAGE

(71) Applicant: Konica Minolta , Inc., Tokyo (JP)

(72) Inventors: Toshiyuki FUJITA, Tokyo (JP); Mari KONISHI, Tokyo (JP)

(73) Assignee: Konica Minolta , Inc., Tokyo (JP)

(21) Appl. No.: 14/028,597

(22) Filed: Sep. 17, 2013

(30) Foreign Application Priority Data
Oct. 18, 2012 (JP) 2012-230726

(51) Int. Cl. G03G 13/22

(52) U.S. Cl. CPC G03G 13/22
USPC 430/55

(57) ABSTRACT

A method for forming an electrophotographic image is provided which exhibits high toner transfer efficiency without image defects caused by scratches on a photoreceptor and image blurring under high-humidity conditions. The method for forming an electrophotographic image uses an organic photoreceptor and includes a charging step, exposing step, developing step, transferring step and cleaning step. The organic photoreceptor has a photosensitive layer and a protective layer on an electrically conductive support. The protective layer contains a resin prepared by polymerization of a polymerizable compound, a particulate metal oxide, and a compound represented by a formula (1). The developing step uses a toner containing a silica particle having a number-average primary particle diameter of 70 to 150 nm. The formula (1) is:

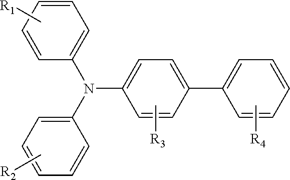

where R₁, R₂, R₃, and R₄ may be same or different and each represents a hydrogen atom or an alkyl group.

### TECHNICAL FIELD

This application is based upon and claims the benefit of priority from the prior Japanese Patent Application No. 2012-230726, filed on Oct. 18, 2012, and the entire contents of which are incorporated herein by reference.

The present invention relates to a method for forming an electrophotographic image. More specifically, the present invention relates to a method for forming an electrophotographic image which exhibits high transfer efficiency of toner without image defects caused by scratches on a surface of an organic photoreceptor and image blurring under high-humidity conditions.

### BACKGROUND ART

In recent years, organic photoreceptors containing an organic photoconductive material have been widely employed as an electrophotographic photoreceptor. The organic photoreceptors have such advantages over inorganic photoreceptors as ease of development of materials corresponding to various exposure light sources ranging from visible to infrared light, selectability of materials free from environmental contamination and low manufacturing cost.

The electrophotographic photoreceptors (hereinafter also referred to simply as “photoreceptor”) are required to have durability such as electric charge stability and electrical potential retention capability over repeated image formation cycles since they receive electrical and external mechanical forces directly exerted by charging, exposing, developing, transferring, cleaning and the like.

In order to improve the durability of such a photoreceptor, technical means has been proposed to provide a protective layer (hereinafter also referred to as “surface layer”) on a surface of the photoreceptor to enhance its mechanical strength.

For example, JP11-288121A discloses a technique to produce a photoreceptor having high durability against wear or scratches of its surface caused by friction of a cleaning blade or the like. In the process, a polymerizable compound, commonly referred to as a curable compound, is applied onto a protective layer of the photoreceptor and is then polymerized. Furthermore, JP2002-333733A discloses a technique to provide a photoreceptor having a protective layer containing dispersed fine metal oxide particles and thus giving enhanced mechanical strength.

Unfortunately, when a protective layer is provided on the photosensitive layer, the sensitivity characteristics as the electrophotographic photoreceptor becomes lower than that having no protective layer since the protective layer has poor charge (carrier) transportability. To solve this problem, technical means to provide a protective layer having high charge transportability as well as high wear resistance has been disclosed. For example, JP2010-164646A discloses a protective layer which is formed by a curing reaction of a radical polymerizable compound having charge transportability, a radical polymerizable compound having no charge transportability, and metal oxide particles modified with a surface-treating agent having a polymerizable functional group (also referred to as a polymerizable reactive group). The technology combining a radical polymerizable compound having charge transportability and metal oxide particles, however, did not achieve sufficient charge transport properties although wear-resistance is improved to some extent. Another problem is occurrence of blur images in high-humidity environments after deposition of the discharge products such as nitrogen oxides resulted from repeated charge and exposure cycles.

It is well known that additives (also referred to as “external additives” hereinafter) such as inorganic or organic fine particles are compounded to the toner used in electrophotographic imaging for the purpose of improved fluidity and charge control of the toner. JP2012-88420A discloses large-diameter silica particles, which have a relatively large particle size, can be advantageously used as additives to improve transfer capability of the toner because such silica particles can reduce contact area between the toner and the photoreceptor.

### SUMMARY OF INVENTION

However, poor adhering strength between the large-diameter silica and the toner causes the silica to transfer readily to the surface of the photoreceptor, which phenomenon leads to the trap of the silica particles on the cleaning blade, resulting in defects such as scratches and uneven wear of the surface of the photoreceptor.

It is an object of the present invention, which has been made in view of the above-described problem and situation, to provide a method for forming an electrophotographic image which exhibits high transfer efficiency of toner without image defects caused by scratches on a surface of an organic photoreceptor and image blurring under high-humidity conditions.

### Solution to Problem

In course of examining the causes of the above-described problems to solve the problems, the present inventors have found that high transfer efficiency of toner without image defects caused by scratches on a surface of the organic photoreceptor and image blurring under high-humidity conditions can be achieved by a method for forming an electrophotographic image which includes a development step, with an organic photoreceptor having a protective layer, using toner containing silica particles having a number-average primary particle diameter of 70 to 150 nm (also referred to as large-diameter silica particles), which has led to the present invention.

To achieve at least one of the abovementioned objects, a method for forming an electrophotographic image uses an organic photoreceptor and includes at least a charging step, an exposing step, a developing step, a transferring step, and a cleaning step. The organic photoreceptor has at least a photosensitive layer and a protective layer on an electrically conductive support. The protective layer contains a resin prepared by polymerization of a polymerizable compound, a particulate metal oxide and a compound represented by a general formula (1). The developing step uses a toner containing silica particle having a number-average primary particle diameter of 70 to 150 nm.

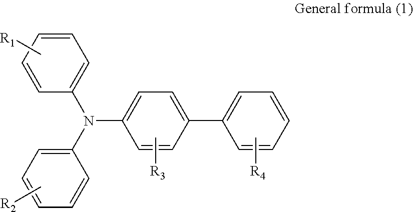

In the formula (1), R₁, R₂, R₃ and R₄ may be the same or different and each represents a hydrogen atom or an alkyl group.

In the method for forming an electrophotographic image, preferably the particulate metal oxide is a particulate tin oxide.

In the method for forming an electrophotographic image, preferably a diameter of the particulate metal oxide is 3 to 100 nm.

In the method for forming an electrophotographic image, preferably surface of the particulate metal oxide is treated with a silane coupling agent having a radical polymerizable functional group.

In the method for forming an electrophotographic image, preferably R₁ and R₂ in the formula are different from each other.

In the method for forming an electrophotographic image, preferably an amount of the compound represented by the formula (1) is 5 to 50 parts by mass relative to 100 parts by mass of the polymerizable compound.

In the method for forming an electrophotographic image, preferably a polymerization initiator for polymerizing the polymerizable compound is an alkylphenone compound or phosphine oxide compound.

In the method for forming an electrophotographic image, preferably the polymerization initiator has an acylphosphine oxide structure.

In the method for forming an electrophotographic image, preferably the toner comprises a styrene-acrylic-modified polyester resin.

In the method for forming an electrophotographic image, preferably an amount of the particulate silica is 0.7 to 3.0 parts by mass relative to 100 parts by mass of a toner base material.

Another aspect of the invention is a device for forming an electrophotographic image including an organic photoreceptor, a charging unit, an exposing unit, a developing unit, a transferring unit, and a cleaning unit. The organic photoreceptor has at least a photosensitive layer and a protective layer on an electrically conductive support. The protective layer contains a resin prepared by polymerization of a polymerizable compound, a particulate metal oxide and a compound represented by a formula (1). The developing unit uses a toner containing silica particles having a number-average primary particle diameter of 70 to 150 nm. The formula (1) is:

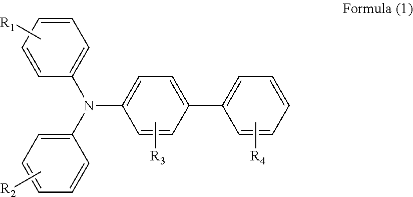

where R₁, R₂, R₃, and R₄ may be the same or different and each represents a hydrogen atom or an alkyl group.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a schematic view illustrating a layer configuration of a photoreceptor according to an example of the present invention.

FIG. 2 is a schematic view illustrating a device for forming an electrophotographic image including a photoreceptor according to an example of the present invention.

### DESCRIPTION OF EMBODIMENTS

A method for forming an electrophotographic image according to the present invention uses an organic photoreceptor and the method includes at least a charging step, exposing step, developing step, transferring step, and cleaning step. The organic photoreceptor has a photosensitive layer and a protective layer on an electrically conductive support. The protective layer contains a resin prepared by polymerization of a polymerizable compound, a particulate metal oxide and a compound represented by the general formula (1), and toner containing silica particles that have a number-average primary particle diameter of 70 to 150 nm is used in the developing step. This configuration is a common technical feature to the invention of claim 1 and its dependent claims.

In the present invention, the particulate metal oxide is preferably particulate tin oxide since it can form a robust protective layer without impairing the charge (carrier) transportability.

In the present invention, preferably a number-average primary particle diameter of the particulate metal oxide is in the range from 3 to 100 nm since the condition does not interrupt penetration of exposure light and can form a tough protective layer.

In the present invention, preferably surface of the particulate metal oxide is treated with a silane coupling agent having a radical polymerizable functional group. The silane coupling agent reacts with the polymerizable compound either so as to form a tough protective layer.

In the present invention, preferably R₁ and R₂ in the general formula (1) are different from each other in view of stable production of the protective layer.

In the present invention, preferably an amount of the compound represented by the formula (1) is 5 to 50 parts by mass relative to 100 parts by mass of the polymerizable compound from the viewpoint to keep electrophotocharacteristics of the photoreceptor while maintaining toughness of the protective layer.

In the present invention, preferably a polymerization initiator for polymerizing the polymerizable compound is an alkylphenone compound or phosphine oxide compound since it makes possible to conduct the polymerization by light irradiation.

In the present invention, preferably the polymerization initiator has an acylphosphine oxide structure since it has a high light-reactivity.

Preferably, the toner contains the styrene-acrylic-modified polyester resin because the feature contributes excellent low temperature-fixing properties and stable formation of high-quality images.

Preferably, an amount of the particulate silica is 0.7 to 3.0 parts by mass relative to 100 parts by mass of a toner base material since it can improve developing and transfer efficiency of the toner.

According to the embodiments, a method for forming an electrophotographic image which exhibit high toner transfer efficiency without image defects caused by scratches on the photoreceptor and image blurring under high-humidity conditions can be provided.

The underlying mechanism of the effects of the present invention has not been clarified yet but it is presumed as follows.

A method for forming an electrophotographic image generally involves transferring a toner image formed on a photoreceptor to a transfer medium such as a transfer sheet or a transfer belt, with part of the toner on the photoreceptor remaining. An increased amount of residual toner puts an overload on the cleaning blade, resulting in accelerated degradation of the cleaning blade or causing a cleaning failure which will cause image defects. The effective way to solve this problem is to add large-diameter silica particles as an external additive with the toner. The large-diameter silica particles as an external additive can reduce the contact area between the toner and the photoreceptor and improve transfer efficiency of the toner. However, part of the large-diameter silica particles transfers to the surface of the photoreceptor due to their poor adhesion to the toner. As a result, the large-diameter silica particles are trapped on the cleaning blade and the accumulated large-diameter silica particles may cause scratches, resulting in image defects or uneven wear, i.e., partial wear on the surface of the photoreceptor.

Probably, the use of an organic photoreceptor with a robust protective layer can prevent the occurrence of scratches and uneven wear, and the frictional force of the large-diameter silica particles appropriately abrade the surface of the photoreceptor to remove nitrogen oxides deposited on the surface of the photoreceptor due to repeated charging and exposure cycles, which resulted in a reduction in image blurring. In a preferred embodiment, the use of a toner containing a styrene-acrylic-modified polyester resin had a tendency to suppress the detachment of the large-diameter silica particles, although the reason is still unclear.

Hereafter, the structural elements of the present invention and embodiments for carrying out the present invention will be described in detail. In the present description, the symbol “-” is used to indicate a range between two numerals described before and after this symbol, and the range includes the two numerals as the lowest value and the highest value.

### (Organic Photoreceptor)

The organic photoreceptor according to the present invention is an electrophotographic photoreceptor having at least a photosensitive layer and a protective layer laminated on an electrically conductive support in this order, in which the protective layer at least contains a resin prepared by polymerization of a polymerizable compound, a particulate metal oxide, and a compound represented by the general formula (1).

### (Structure of Protective Layer)

### (Polymerizable Compound)

The protective layer according to the present invention contains a resin prepared by polymerization of a polymerizable compound. Examples of the polymerizable compound that can be used in the protective layer according to the present invention include radical polymerizable compounds. The radical polymerizable compound is preferably a polymerizable monomer having either an acryloyl group or methacryloyl group as a radical polymerizable reactive group.

Examples of the polymerizable monomers include, but not limited to, the following compounds:

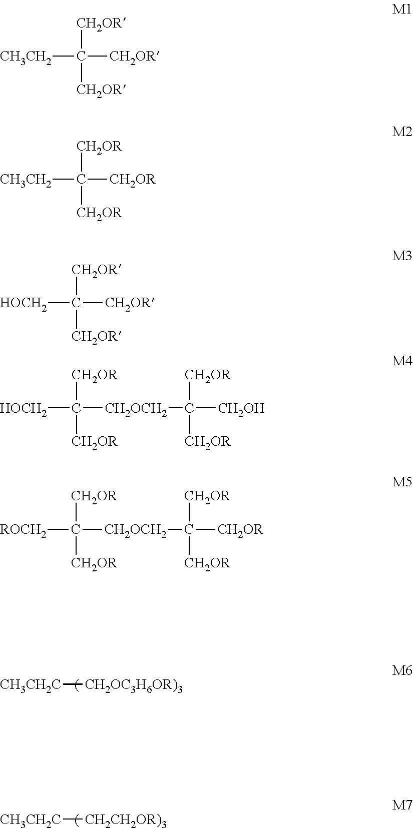

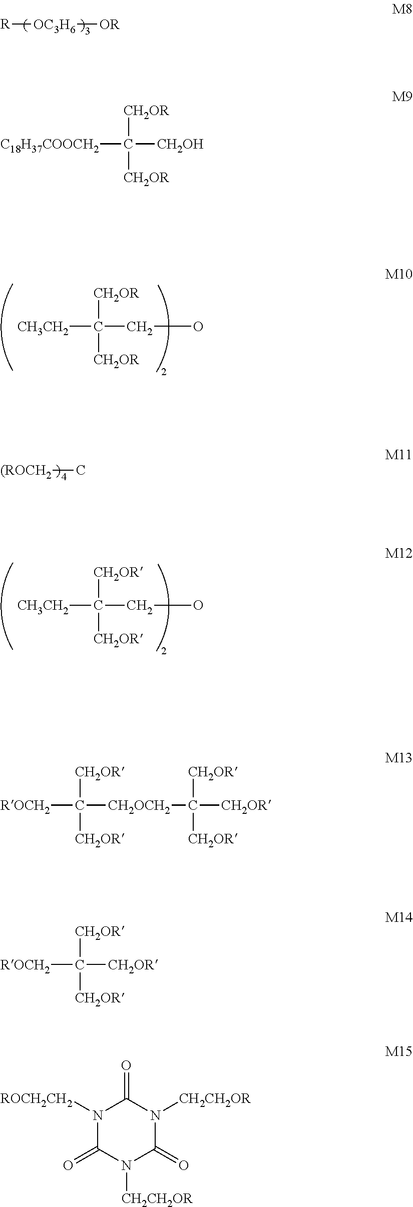

Where R is the following acryloyl group and R′ represents the following methacryloyl group:

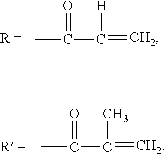

These radical polymerizable compounds are known and are commercially available. A radical polymerizable compound having three or more functional groups (reactive groups) is preferably used. Furthermore, two or more radical polymerizable compounds may be used in combination. Even in such a case, the content of the radical polymerizable compound having three or more functional groups is preferably at least 50% by mass.

### (Particulate Metal Oxide)

Examples of the particulate metal oxide used in the protective layer of the organic photoreceptor include particles of metal oxides such as silica (silicon oxide), magnesium oxide, zinc oxide, lead oxide, alumina (aluminum oxide), zirconium oxide, tin oxide, titania (titanium oxide), niobium oxide, molybdenum oxide, and vanadium oxide. In particular, particulate tin oxide is preferable since tin oxide particles can deliver charge transportability by a small volume of particles owing to their low resistance and high density.

The particulate metal oxide according to the present invention can be produced by any known process without limitation.

The particulate metal oxide according to the present invention has a number-average primary particle diameter in the range of preferably 1 to 300 nm, particularly in the range of 3 to 100 nm.

### (Measurement of Number-Average Primary Particle Diameter of Particulate Metal Oxide)

The number-average primary particle diameter of the particulate metal oxide is determined in such a manner that the particles are photographed at a magnification of 100,000 with a scanning electron microscope (manufactured by JEOL Ltd.), photographic images of randomly selected 100 particles read by a scanner (excluding agglomerated particles) are converted to binary images with an automatic image analyzer “LUZEX AP (manufactured by NIRECO Corp.)” provided with software version Ver. 1.32, and horizontal Feret diameters of the randomly-selected 100 particles are calculated and the average value of the Feret diameters is defined as the number-average primary particle diameter. The horizontal Feret diameter is a length of a side of the bounding rectangle of the binary image of the particulate metal oxide parallel to the x-axis.

### (Surface-Treated Particulate Metal Oxide)

The particulate metal oxide used in the protective layer according to the present invention is preferably treated with a surface-treating agent.

### (The Surface-Treating Agent)

The surface-treating agent according to the present invention preferably reacts with hydroxyl group and the like present on a surface of the particulate metal oxide, and examples thereof include silane coupling agents and titanium coupling agents.

Examples of the silane coupling agent preferably used as a surface-treating agent according to the present invention include poly dimethylsiloxane, hexamethyldisilazane, polymethylhydrogensiloxane, methyltriethoxysilane, n-octyltriethoxysilane, 3-methacryloxypropyltrimethoxysilane, and 3-aminopropyltriethoxysilane.

The surface-treating agent according to the present invention preferably has a reactive organic group, preferably a radical polymerizable reactive group for further increasing the hardness of the protective layer. The radical polymerizable reactive group can react with the polymerizable compound according to the present invention to form a robust protective film. The preferable surface-treating agent having a radical polymerizable reactive group is a silane coupling agent having a radical polymerizable reactive group such as a vinyl group, an acryloyl group, and methacryloyl group. Examples of the surface-treating agent having such a radical group include known compounds exemplified below.

### S-1: CH₂═CHSi(CH₃)(OCH₃)₂

### S-2: CH₂═CHSi(OCH₃)₃

### S-3: CH₂═CHSiCl₃

### S-4: CH₂═CHCOO(CH₂)₂Si(CH₃)(OCH₃)₂

### S-5: CH₂═CHCOO(CH₂)₂Si(OCH₃)₃

### S-6: CH₂═CHCOO(CH₂)₂Si(OC₂H₅)(OCH₃)₂

### S-7: CH₂═CHCOO(CH₂)₃Si(OCH₃)₃

### S-8: CH₂═CHCOO(CH₂)₂Si(CH₃)Cl₂

### S-9: CH₂═CHCOO(CH₂)₂SiCl₃

### S-10: CH₂═CHCOO(CH₂)₃Si(CH₃)Cl₂

### S-11: CH₂═CHCOO(CH₂)₃SiCl₃

### S-12: CH₂═C(CH₃)COO(CH₂)₂Si(CH₃)(OCH₃)₂

### S-13: CH₂═C(CH₃)COO(CH₂)₂Si(OCH₃)₃

### S-14: CH₂═C(CH₃)COO(CH₂)₃Si(CH₃)(OCH₃)₂

### S-15: CH₂═C(CH₃)COO(CH₂)₃Si(OCH₃)₃

### S-16: CH₂═C(CH₃)COO(CH₂)₂Si(CH₃)Cl₂

### S-17: CH₂═C(CH₃)COO(CH₂)₂SiCl₃

### S-18: CH₂═C(CH₃)COO(CH₂)₃Si(CH₃)Cl₂

### S-19: CH₂═C(CH₃)COO(CH₂)₃SiCl₃

### S-20: CH₂═CHSi(C₂H₅)(OCH₃)₂

### S-21: CH₂═C(CH₃)Si(OCH₃)₃

### S-22: CH₂═C(CH₃)Si(OC₂H₅)₃

### S-23: CH₂═CHSi(OCH₃)₃

### S-24: CH₂═C(CH₃)Si(CH₃)(OCH₃)₂

### S-25: CH₂═CHSi(CH₃)Cl₂

### S-26: CH₂═CHCOOSi(OCH₃)₃

### S-27: CH₂═CHCOOSi(OC₂H₅)₃

### S-28: CH₂═C(CH₃)COOSi(OCH₃)₃

### S-29: CH₂═C(CH₃)COOSi(OC₂H₅)₃

### S-30: CH₂═C(CH₃)COO(CH₂)₃Si(OC₂H₅)₃

### S-31: CH₂═CHCOO(CH₂)₂Si(CH₃)₂(OCH₃)

### S-32: CH₂═CHCOO(CH₂)₂Si(CH₃)(OCOCH₃)₂

### S-33: CH₂═CHCOO(CH₂)₂Si(CH₃)(ONHCH₃)₂

### S-34: CH₂═CHCOO(CH₂)₂Si(CH₃)(OC₆H₅)₂

### S-35: CH₂═CHCOO(CH₂)₂Si(C₁₀H₂₁)(OCH₃)₂

### S-36: CH₂═CHCOO(CH₂)₂Si(CH₂CH₅)(OCH₃)₂

Furthermore, besides S-1 to S-36, other silane compounds having a radically reactive organic group can also be used as a surface-treating agent. These surface-treating agents may be used alone or in combination thereof.

### (Method of Preparing Surface-Treated Particulate Metal Oxide)

The surface-treatment is preferably performed using a wet media dispersion apparatus with 0.1 to 100 parts by mass of the surface-treating agent and 50 to 5,000 parts by mass of solvent relative to 100 parts by mass of the particulate metal oxide. Alternatively, the surface-treatment can be performed by a dry process.

A method of surface-treatment will now be described for preparing particulate metal oxide uniformly surface-treated with a surface-treating agent.

Slurry (suspension of solid particles) containing metal oxide particles and a surface-treating agent is wet-pulverized, so that the metal oxide particles becomes fine and surface treatment of the particles proceeds simultaneously. After that the solvent is removed to yield powdered particulate metal oxide which has been uniformly surface-treated with the surface-treating agent.

A wet media dispersion apparatus used for the surface treatment in the present invention includes a container filled with beads as media and a stirring disk perpendicularly attached to a rotation shaft, and can disintegrate the agglomerated particulate metal oxide to disperse pulverized particles by rotating the stirring disk at high rate. Various types of dispersion apparatuses may be employed which can sufficiently disperse and surface-treat the particulate metal oxide during surface treatment, such as vertical, horizontal, continuous, and batch types. Specific examples of the dispersion apparatus include sand mills, ultravisco mills, pearl mills, grain mills, DYNO-mills, agitator mills, and dynamic mills. These dispersion apparatuses employs pulverizing media such as balls or beads for fine pulverization and dispersion by impact pressure crushing, friction, shear force, or shear stress, for example.

Examples of beads usable in the wet medium dispersion apparatus include beads made of various materials such as glass, alumina, zircon, zirconia, steel, and flint stone, and those made of zirconia or zircon are particularly preferred. In general, beads having a particle diameter of about 1 to 2 mm are used, whereas beads having particle diameter of about 0.1 to 1.0 mm are preferred in the present invention.

A disk and inner wall made of ceramics such as zirconia or silicon carbide are particularly preferred in the present invention, while various materials such as stainless steel, nylon, or ceramics may be usually used for the disk and inner wall of the wet medium dispersion apparatus.

The particulate metal oxide treated by a surface-treating agent can be prepared by such a wet process.

According to the present invention, an amount of the particulate metal oxide added to the protective layer is preferably 50 to 300 parts by mass relative to 100 parts by mass of the polymerizable compound for maintaining charge transport capability and toughness of the protective layer.

### (Charge (Carrier) Transport Material)

The protective layer according to the present invention contains a compound represented by a general formula (1). A compound represented by the general formula (1) is a charge (carrier) transport material having charge transport capability (transportability). A protective layer having charge transportability can prevent loss of light sensitive characteristics, which is usually caused by a protective layer provided on the photosensitive layer, and provide an organic photoreceptor having high sensitivity which can produce high contrast and high quality images stably.

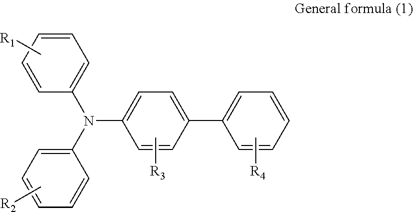

In the formula (1), R₁, R₂, R₃, and R₄ may be the same or different and each represents a hydrogen atom or an alkyl group. The alkyl group may be a straight or a branched alkyl group, preferably a straight alkyl group having 1 to 5 carbon atoms. Furthermore, R₁ and R₂ in the formula (1) are preferably different from each other in view of stable production of the protective layer.

The amount of the compound represented by the formula (1) added to the protective layer is preferably 5 to 50 parts by mass relative to 100 parts by mass of the polymerizable compound since such an amount can maintain the electrophotographic characteristics of the photoreceptor without sacrificing the strength of the protective layer.

Furthermore, the compound represented by the formula (1) has an absorption band in a shorter wavelength region than that of a photopolymerization initiator, which is used for polymerization of the polymerizable compound added to the protective layer, so that the light absorption wavelength region of the compound does not overlap that of the photopolymerization initiator, resulting in the efficient photopolymerization.

Specific examples of the formula (1) are as follows:

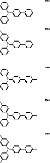 [SMILES: c1ccc(-c2ccc(N(c3ccccc3)c3ccccc3)cc2)cc1 ; Cc1ccc(N(c2ccccc2)c2ccc(-c3ccccc3)cc2)cc1 ; Cc1ccc(-c2ccc(N(c3ccccc3)c3ccccc3)cc2)cc1 ; Cc1ccc(-c2ccc(N(c3ccccc3)c3ccc(C)cc3)cc2)cc1 ; Cc1ccc(-c2ccc(N(c3ccc(C)cc3)c3ccc(C)cc3)cc2)cc1]

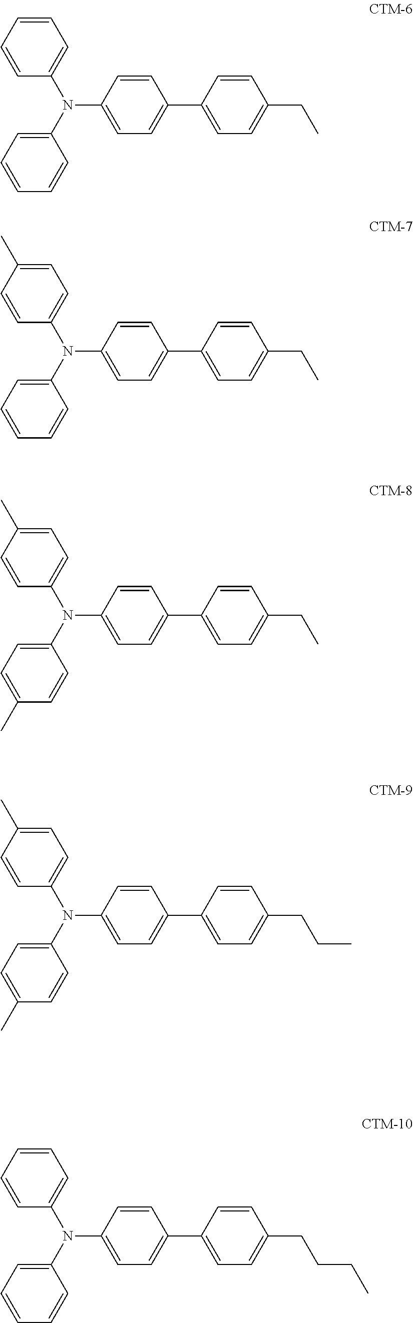 [SMILES: CCc1ccc(-c2ccc(N(c3ccccc3)c3ccccc3)cc2)cc1 ; CCc1ccc(-c2ccc(N(c3ccccc3)c3ccc(C)cc3)cc2)cc1 ; CCc1ccc(-c2ccc(N(c3ccc(C)cc3)c3ccc(C)cc3)cc2)cc1 ; CCCc1ccc(-c2ccc(N(c3ccc(C)cc3)c3ccc(C)cc3)cc2)cc1 ; CCCCc1ccc(-c2ccc(N(c3ccccc3)c3ccccc3)cc2)cc1]

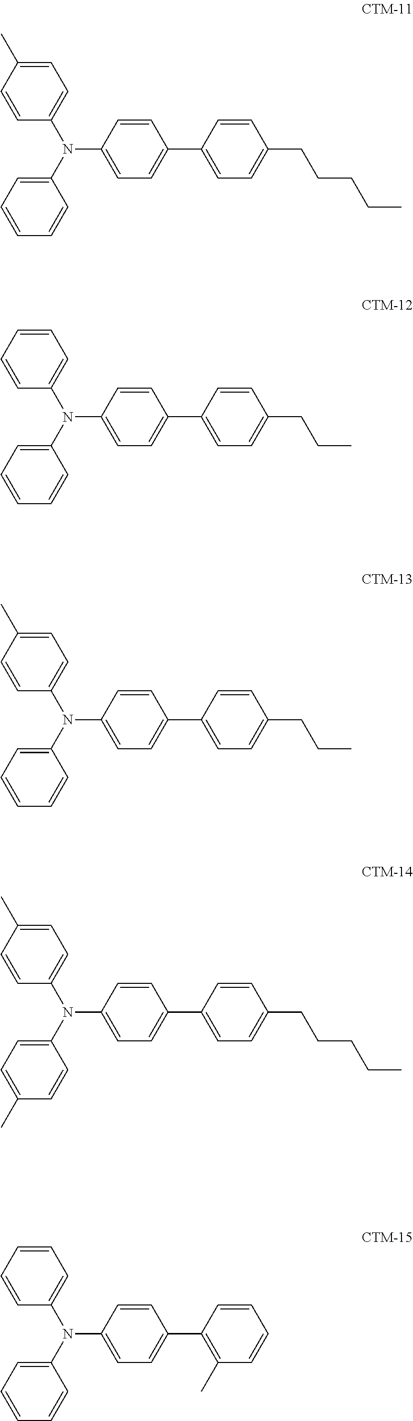 [SMILES: CCCCCc1ccc(-c2ccc(N(c3ccccc3)c3ccc(C)cc3)cc2)cc1 ; CCCc1ccc(-c2ccc(N(c3ccccc3)c3ccccc3)cc2)cc1 ; CCCc1ccc(-c2ccc(N(c3ccccc3)c3ccc(C)cc3)cc2)cc1 ; CCCCCc1ccc(-c2ccc(N(c3ccc(C)cc3)c3ccc(C)cc3)cc2)cc1 ; Cc1ccccc1-c1ccc(N(c2ccccc2)c2ccccc2)cc1]

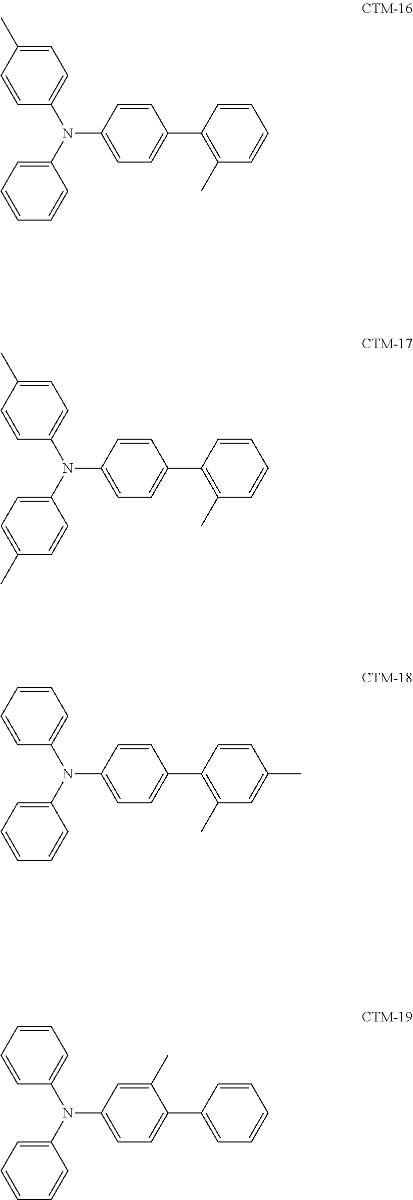 [SMILES: Cc1ccc(N(c2ccccc2)c2ccc(-c3ccccc3C)cc2)cc1 ; Cc1ccc(N(c2ccc(C)cc2)c2ccc(-c3ccccc3C)cc2)cc1 ; Cc1ccc(-c2ccc(N(c3ccccc3)c3ccccc3)cc2)c(C)c1 ; Cc1cc(N(c2ccccc2)c2ccccc2)ccc1-c1ccccc1]

These compounds can be synthesized by the method described, for example, in JP-2006-143720A.

### (Polymerization Initiator)

The method for polymerizing a polymerizable compound usable for the protective layer according to the present invention includes an electron beam cleavage reaction and a photoreaction or thermal reaction in the presence of a radical polymerization initiator, which cause a curing reaction. In the curing reaction using a radical polymerization initiator, either one of a photopolymerization initiator and a thermal polymerization initiator can be used. Furthermore, both of the photopolymerization initiator and the thermal polymerization initiator can be used in combination.

The polymerization initiator usable in the present invention includes thermal initiators, for example, azo compounds such as 2,2′-azobisisobutyronitrile, 2,2′-azobis(2,4-dimethyl-azobisvaleronitrile), and 2,2′-azobis(2-methylbutyronitrile); and peroxides such as benzoyl peroxide (BPO), di-tert-butyl hydroperoxide, tert-butyl hydroperoxide, chlorobenzoyl peroxide, dichlorobenzoyl peroxide, bromomethylbenzoyl peroxide, and lauroyl peroxide.

Furthermore, the photopolymerization initiator includes acetophenone or ketal photopolymerization initiators such as diethoxyacetophenone, 2,2-dimethoxy-1,2-diphenylethan-1-one, 1-hydroxycyclohexyl phenyl ketone, 4-(2-hydreoxyethoxy)phenyl (2-hydroxy-2-propyl)ketone, 2-benzyl-2-dimethylamino-1-(4-morpholinophenyl)butanone-1 (Irgacure 369: BASF Japan Ltd.), 2-hydroxy-2-methyl-1-phenylpropan-1-one, 2-methyl-2-morpholino(4-methylthiophenyl)propan-1-one, and 1-phenyl-1,2-propane dione-2-(o-ethoxy carbonyl)oxime; benzoin ether photopolymerization initiators such as benzoin, benzoin methylether, benzoin ethylether, benzoin isobutylether, and benzoin isopropylether; benzophenone-based polymerization initiators such as benzophenone, 4-hydroxybenzophenone, o-benzoylbenzoate, 2-benzoylnaphthalene, 4-benzoyl biphenyl, 4-benzoyl phenylether, acrylated benzophenone, and 1,4-benzoyl benzene; and thioxanthone-based photopolymerization initiators such as 2-isopropylthioxanthone, 2-chlorothioxanthone, 2,4-dimethylthioxanthone, 2,4-diethylthioxanthone, and 2,4-dichlorothioxanthone.

Examples of other photopolymerization initiators include ethylanthraquinone, 2,4,6-trimethylbenzoyl diphenylphosphine oxide, 2,4,6-trimethylbenzoyl phenylethoxyphosphine oxide, bis(2,4,6-trimethyl benzoyl)phenylphosphine oxide (Irgacure 819: BASF Japan Ltd.), bis(2,4-dimethoxy benzoyl) 2,4,4-trimethylpentyl phosphine oxide, methylphenylglyoxy ester, 9,10-phenanthrene, acridine-based compounds, triazine-based compounds, and imidazole-based compounds. In addition, any compound having an acceleration effect on photopolymerization can be used alone or in combination with the photopolymerization initiator. Specific examples of such compounds include triethanolamine, methyldiethanolamine, 4-dimethyl aminoethylbenzoate, 4-dimethyl aminoisoamylbenzoate, ethyl 2-dimethylaminobenzoate, and 4,4′-dimethyl amino benzophenone.

The polymerization initiator used in the present invention is preferably a photopolymerization initiator, more preferably an alkylphenone compound or phosphine oxide compound, and most preferably an initiator having an α-hydroxyacetophenone structure or acylphosphine oxide structure.

These polymerization initiators can be used alone or in combination. The content of the polymerization initiator ranges from 0.1 to 40 parts by mass, preferably from 0.5 to 20 parts by mass relative to 100 parts by mass of the polymerizable compound.

### (Solvent)

Specific examples of the solvent used to form the protective layer include, but are not limited to, methanol, ethanol, 1-propanol, 2-propanol, 1-butanol, 2-butanol, 2-methyl-2-propanol, benzyl alcohol, methyl isopropyl ketone, methyl isobutyl ketone, methyl ethyl ketone, cyclohexane, toluene, xylene, methylene chloride, ethyl acetate, butyl acetate, 2-methoxyethanol, 2-ethoxyethanol, tetrahydrofuran, 1-dioxane, 1,3-dioxolane, pyridine, and diethylamine.

### (Formation of Protective Layer)

The protective layer can be formed in the following procedure. A coating solution is prepared by addition of a polymerizable compound, metal oxide particles, a compound of the formula (1), and optional known materials such as a resin, a polymerization initiator, any other lubricant particle, and an antioxidant; the resulting solution is applied onto the surface of the photosensitive layer by any known process, followed by natural or thermal drying; and then the coating is cured to form the protective layer. The thickness of the protective layer ranges preferably from 0.2 to 10 μm and more preferably from 0.5 to 6 μm.

The protective layer of the present invention is formed preferably by exposing the coated layer to active rays to generate radicals for polymerization, and forming crosslinking bonds via intermolecular and intramolecular crosslinking reaction to produce a cured resin. Light such as ultraviolet light and visible light and electron beams are preferred as the active ray. Ultraviolet light is particularly preferred in view of ease of use.

Any light source which generates ultraviolet light can be used without limitation. Specific examples of the light source include low pressure mercury lamps, intermediate pressure mercury lamps, high pressure mercury vapor lamps, ultrahigh pressure mercury lamps, carbon arc lamps, metal halide lamps, xenon lamps, flash (pulse) xenon lamps, and ultraviolet LEDs. The irradiation condition varies depending on the lamp to be used. The dose of active rays is normally in the range from 1 to 20 mJ/cm², preferably in the range from 5 to 15 mJ/cm². The output voltage of the light source is preferably in the range from 0.1 to 5 kW, and more preferably in the range from 0.5 to 3 kW.

Any electron beam irradiation apparatus can be used without limitation for an electron beam source. In general, an electron beam accelerator of a curtain beam system capable of producing high power at relatively low cost is advantageously used for such electron beam irradiation. The acceleration voltage during electron beam irradiation is preferably in the range of 100 to 300 kV. The absorbed dose is preferably kept in the range of 0.005 Gy to 100 kGy (0.5 rad to 10 Mrad).

The irradiation time to provide the required dose of active rays ranges preferably from 0.1 sec to 10 min, and more preferably from 1 sec to 5 min from the viewpoint of curing efficiency and work efficiency.

In the present invention, the protective layer can be subjected to a drying treatment before, during or after the irradiation of the active ray and the time of the drying treatment can be appropriately selected in view of irradiation conditions. The drying conditions of the protective layer can be appropriately selected depending on the type of the solvent used in the coating solution and the thickness of the protective layer. The drying temperature is preferably in the range of room temperature to 180° C., particularly 80 to 140° C. The drying time is preferably in the range of 1 to 200 min, particularly in the range of 5 to 100 min. In the present invention, the drying condition described above for drying the protective layer can control the amount of the solvent contained in the protective in the range of 20 ppm to 75 ppm.

### [Layer Configuration of Organic Photoreceptor]

The organic photoreceptor according to the present invention is composed of a photosensitive layer and a protective layer formed on an electrically conductive support. The photosensitive layer of the present invention may have any layer configuration, and exemplary configurations are:

(1) a layer configuration in which a charge (carrier) generation layer, a charge (carrier) transport layer and a protective layer are laminated in this order on an electrically conductive support;
(2) a layer configuration in which a single layer containing charge transport material and charge generation material and a protective layer are laminated in this order on an electrically conductive support;
(3) a layer configuration in which an intermediate layer, a charge generation layer, a charge transport layer and a protective layer are laminated in this order on an electrically conductive support; and
(4) a layer configuration in which an intermediate layer, a single layer containing charge transport material and charge generation material, and a protective layer are laminated in this order on an electrically conductive support.

The organic photoreceptor according to the present invention may have any one of the layer configurations (1) to (4). Among these, the photoreceptor having the layer configuration (3) is particularly preferred.

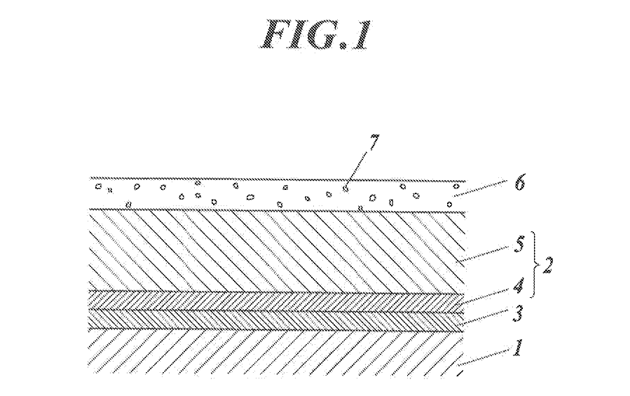

FIG. 1 is a schematic view illustrating an example of a layer configuration of a photoreceptor according to the present invention. In FIG. 1, numeral 1 represents an electrically conductive support, numeral 2 represents a photosensitive layer, numeral 3 represents an intermediate layer, numeral 4 represents a charge generation layer, numeral 5 represents a charge transport layer, numeral 6 represents a protective layer and numeral 7 represents a surface-treated particulate metal oxide.

The electrically conductive support, intermediate layer and photosensitive layers (the charge generation layer and charge transport layer) which constitute the organic photoreceptor and components which constitute the photosensitive layer according to the present invention will be described.

### (Electrically Conductive Support)

Any electrically conductive support can be used without limitation in the present invention as far as it possesses electric conductivity. The examples thereof include: drum or sheet-formed metal of aluminum, copper, chromium, nickel, zinc, stainless steel or the like; a plastic film on which a metal foil made of aluminum, copper or the like is laminated; a plastic film on which aluminum, indium oxide, tin oxide or the like is deposited; and a metal, plastic film, or paper sheet provided with a conductive layer formed by coating a conductive substance alone or in combination with binder resins.

### (Intermediate Layer)

An intermediate layer having a barrier function and an adhesion function can be provided between the electrically conductive support and a photosensitive layer in the present invention. The intermediate layer can be formed in such a manner that a binder resin such as casein, polyvinyl alcohol, nitrocellulose, ethylene-acrylic acid copolymer, polyamide, polyurethane or gelatin is dissolved in a known solvent and the resulting solution is applied, for example, by dip coating. Among these materials, alcohol-soluble polyamide resin is preferred.

Various kinds of electrically conductive fine particles or metal oxide particles may be contained in the intermediate layer to control resistance. Examples thereof include metal oxide particles, such as particles of alumina, zinc oxide, titanium oxide, tin oxide, antimony oxide, indium oxide, and bismuth oxide. Furthermore, ultra-fine particles, such as particles of tin-doped indium oxide, antimony doped tin oxide, and antimony doped zirconium oxide can be used. These metal oxide particles can be used alone or in combination. When combining two or more kinds of particles, they may be a solid solution or fusion state. The number-average primary particle diameter of the particulate metal oxide is preferably 0.3 μm or less and more preferably 0.1 μm or less.

Preferably the solvent used for forming the intermediate layer can sufficiently disperse inorganic particles such as conductive fine particles or metal oxide particles and dissolve binder resins such as a polyamide resin. Examples of the preferred solvent include alcohols containing two to four carbon atoms such as ethanol, n-propyl alcohol, isopropyl alcohol, n-butanol, t-butanol, and sec-butanol, all of which have high solubility for polyamide resins and bring out high coating characteristics. Furthermore, an auxiliary solvent can be used to improve storage stability and particle dispersion. Examples of effective auxiliary solvents include methanol, benzyl alcohol, toluene, cyclohexane, and tetrahydrofuran.

The concentration of the binder resin in the coating solution is appropriately selected depending on the thickness of the intermediate layer and the type of the coating process. The amount of the mixed inorganic particles, when dispersed, is in the range of preferably 20 to 400 parts by mass, more preferably 50 to 200 parts by mass relative to 100 parts by mass of the binder resin.

Metal oxide particles can be dispersed by any nonlimiting means, for example, an ultrasonic dispersing machine, a ball mill, a sand grinder, and a homogenizer.

The method of drying the intermediate layer can be appropriately selected from known drying processes depending on the solvent used and the thickness of the film formed. Thermal drying is particularly preferred.

The thickness of the intermediate layer is preferably in the range of 0.1 to 15 μm and more preferably 0.3 to 10 μm.

### (Photosensitive Layer)

As described above, the photosensitive layer constituting the photoreceptor according to the present invention may have a single layer structure provided with a charge generation function and a charge transport function. However, a multilayer configuration including two functionally separated layers, i.e., a charge generation layer (CGL) and a charge transport layer (CTL) is preferred. The functionally separated layer configuration can minimize the increase in residual potential generated during repeated use and readily control various electrophotographic characteristics to requirements. A layer configuration of a negatively charged photoreceptor includes an intermediate layer, a charge generation layer (CGL) provided thereon, and a charge transport layer (CTL) on the charge generation layer, while a layer configuration of a positively charged photoreceptor includes an intermediate layer, a charge transport layer (CTL) provided thereon, and a charge generation layer (CGL) on the charge transport layer. A preferred layer configuration of the photosensitive layer is the functionally separated configuration of the negatively charged photoreceptor.

Each photosensitive layer of the functionally separated negatively charged photoreceptor will now be described.

### (Charge Generation Layer)

The charge generation layer contains a compound (charge generating material) capable of absorbing light to generate charges, i.e., electrons and holes. The charge generation layer of the present invention, which contains a charge generating material and a binder resin, is preferably formed by applying a coating liquid containing charge generating materials dispersed in a binder resin solution.

Examples of the charge generating material include, but not limited to, azo compounds, such as Sudan Red and Diane Blue; quinone pigments, such as pyrene quinone and anthanthrone; quinocyanine pigments; perylene pigments; indigo pigments, such as indigo and thioindigo; and phthalocyanine pigments. These charge generating materials can be used alone or in the form dispersed in a known binder resin.

Examples of the binder resin for the charge generation layer include known resins, without limitation, such as polystyrene resins, polyethylene resins, polypropylene resins, acrylic resins, methacrylic resins, vinyl chloride resins, vinyl acetate resins, polyvinyl butyral resins, epoxy resins, polyurethane resins, phenol resins, polyester resins, alkyd resins, polycarbonate resins, silicone resins, melamine resins, copolymer resins containing at least two of these resin structures (e.g., vinyl chloride-vinyl acetate copolymer resins, and vinyl chloride-vinyl acetate-anhydrous maleic acid copolymer resins), and polyvinylcarbazole resins.

The charge generation layer is preferably formed in such a manner that a charge generating material is dispersed in a solution, which a binder resin is dissolved in a solvent, using a dispersion apparatus to prepare a coating liquid, the solution is then applied with a coater to give a film with a predetermined thickness and the film is dried into a charge generation layer.

Examples of the solvent for dissolving a binder resin for coating used for the charge generation layer include, but not limited to, toluene, xylene, methyl ethyl ketone, cyclohexane, ethyl acetate, butyl acetate, methanol, ethanol, propanol, butanol, methyl cellosolve, ethyl cellosolve, tetrahydrofuran, 1-dioxane, 1,3-dioxolane, pyridine, and diethylamine.

Examples of the dispersing device for the charge generating material include, but not limited to, an ultrasonic dispersing machine, a ball mill, a sand grinder, and a homogenizer.

An amount of the charge generating material is preferably in the range of 1 to 600 parts by mass, and more preferably 50 to 500 parts by mass, relative to 100 parts by mass of the binder resin. The thickness of the charge generation layer varies depending on properties of the charge generating material, properties of the binder resin, and the mixing ratio thereof, and ranges from preferably 0.01 to 5 μm, and more preferably 0.05 to 3 m. Generation of image defects can be prevented by filtering out foreign matter and agglomerates before application of a coating composition for the charge generation layer. The charge generation layer can also be formed by vacuum deposition of the pigments described above.

### (Charge Transport Layer)

A charge transport layer is a layer for transporting charges generated in the charge generation layer. The charge transport layer in the negatively charged photoreceptor generally contains a charge transport material having hole transport property. The charge transport layer used in a photosensitive layer of the present invention contains at least a charge transport material and a binder resin and is formed by coating a binder resin solution dissolving the charge transport material therein.

Examples of the charge transport material having the hole transport property can include known compounds, without limitation, such as carbazole derivatives, oxazole derivatives, oxadiazole derivatives, thiazole derivatives, thiadiazole derivatives, triazole derivatives, imidazole derivatives, imidazolone derivatives, imidazolidine derivatives, bis-imidazolidine derivatives, styryl compounds, hydrazone compounds, pyrazoline compounds, oxazolone derivatives, benzimidazole derivatives, quinazoline derivatives, benzofuran derivatives, acridine derivatives, phenazine derivatives, aminostilbene derivatives, triaryl amine derivatives, phenylenediamine derivatives, stilbene derivatives, benzidine derivatives, poly(N-vinyl carbazole), poly(1-vinyl pyrene) and poly(9-vinyl anthracene), and these may be used alone or in combination thereof.

Examples of the binder resin for the charge transport layer include known resins such as, without limitation, polycarbonate resins, polyacrylate resins, polyester resins, polystyrene resins, styrene-acrylonitrile copolymer resins, polymethacrylate resins, and styrene-methacrylate copolymer resins. In particular, polycarbonate resins are preferred. Furthermore, Bisphenol A (BPA), Bisphenol Z (BPZ), dimethyl BPA, and BPA-dimethyl BPA copolymers are preferred in view of cracking resistance, abrasion resistance and electrostatic-charging characteristics.

The charge transport layer can be formed by any known process such as coating. For example, in the coating process, a desired charge transport layer can be formed by dissolving a binder resin and a charge transport material to prepare a coating solution, which is then applied into a predetermined thickness and then dried.

The examples of the solvent for dissolving the binder resin and the charge transport material include, but not limited to, toluene, xylene, methyl ethyl ketone, cyclohexanone, ethyl acetate, butyl acetate, methanol, ethanol, propanol, butanol, tetrahydrofuran, 1,4-dioxane, and 1,3-dioxolane. It should be noted that the solvent used to prepare a coating solution for the charge transport layer is not limited to those solvents.

The amount of charge transport material is preferably in the range of 10 to 500 parts by mass, more preferably 20 to 100 parts by mass, relative to 100 parts by mass of binder resin.

The thickness of the charge transport layer varies depending on the properties of the charge transport material and the binder resin, and the proportion thereof, and ranges preferably from 5 to 40 μm, more preferably from 10 to 30 μm.

A known antioxidant can be contained in the charge transport layer. For example, the antioxidants listed in JP2000-305291A can be used.

### (Method of Coating Photoreceptor)

Each layer which constitutes the photoreceptor according to the present invention such as the intermediate layer, the charge generation layer, the charge transport layer and the protective layer can be formed according to well-known processes such as dip coating, spray coating, spinner coating, bead coating, blade coating, beam coating, and circular amount-regulating coating (circular slide hopper coating). The circular amount-regulating coating method is disclosed, for example, JP-S58-189061A and JP2005-275373A.

### (Particulate Silica)

The present invention provides a method and a device for forming an electrophotographic image which exhibit high transfer efficiency without image defects caused by scratches on the photoreceptor and image blurring under high-humidity conditions by using a toner containing particulate silica having a number-average primary particle diameter of 70 to 150 nm as external additives.

In the present invention, the particulate silica is not embedded under a surface of the toner base particles even under the mechanical stress in the developing unit by the reason that the particulate silica have a number-average primary particle diameter within the above-defined range and thus the developability and transferability can be maintained and the detachment from the photoreceptor during development and transfer also can be prevented. Furthermore, the monodispersion silica particles allows for maintaining appropriate charging performance even in low-temperature and low-humidity environments or in high-temperature and high-humidity environments, resulting in excellent developability and improved transferability The particulate silica according to the present invention is preferably prepared by a sol-gel process. This process is characterized by producing particulate silica having a large and uniform particle size (having a narrow particle size distribution, i.e., monodisperse) compared with particulate fumed silica prepared by a common process.

### (Measurement of Number-Average Primary Particle Diameter of Particulate Silica)

The number-average primary particle diameter of the particulate silica is determined by image analysis. Specifically, the silica particles are photographed at a magnification of 100,000 with a scanning electron microscope (JSM-7401: manufactured by JEOL Ltd.) and the photographic image read by a scanner is converted to a binary image with an automatic image analyzer, “LUZEX™ AP (manufactured by NIRECO Corp.) provided with software version Ver. 1.32, and the horizontal Feret diameters of random 100 particles are calculated and the average value of the Feret diameters is defined as the number-average primary particle diameter. The horizontal Feret diameter is a length of a side, which is parallel to the x-axis, of the circumscribed rectangle of the binary image of the external additives.

Standard deviation of the number-average primary particle diameter can be determined from the measured primary particle sizes of the 100 particles.

In the present invention, the number-average primary particle diameter of the silica particles is in the range of 70 to 150 nm, preferably in the range of 80 to 120 nm. The silica particles having a number-average primary particle diameter within this range can adjust the adhesive force between the toner particles and the photoreceptor within the preferable range.

### (Monodisperse)

The particulate silica according to the present invention is preferably monodisperse. The term “monodisperse” in the present invention is defined as follows.

The dispersity in the particle size distribution can be discussed in terms of the standard deviation to the mean particle size including agglomerates. The particles having the standard deviation of a number-average primary particle diameter of “not more than {(a number-average primary particle diameter)×0.22}” are defined to be “monodisperse”.

### (Sphericity)

The sphericity of the particulate silica in the present invention was determined using the “degree of true sphericity” defined by Wadell.

That is, the sphericity is given by the following expression (A).

Sphericity=(surface area of a sphere having the same volume as the given particle)/(actual surface area of the given particle), Expression (A)

where the numerator “surface area of a sphere having the same volume as the given particle” was determined through arithmetic calculation from the number-average primary particle diameter.

The denominator “actual surface area of the particle” was substituted with BET specific surface measured by a powder specific surface area analyzer (SS-100 Model, manufactured by Shimadzu Corporation).

In the present invention, the sphericity of the particulate silica is preferably 0.6 or more, more preferably 0.8 or more. The particulate silica with a sphericity of 0.6 or more provides improved developability and transferability.

The particulate silica according to the present invention, which is monodisperse and spherical, can be dispersed uniformly on the surface of the toner base particles, so as to achieve a stable spacer effect.

The monodisperse spherical silica in the range of 70 to 150 nm of number-average primary particle diameter in the present invention can be prepared by a wet sol-gel process. The silica is prepared by a wet process without calcination, so that the true specific gravity can be controlled to be lower than that of silica prepared by a vapor phase oxidation process. In addition, the specific gravity can be more precisely adjusted by controlling the type of the hydrophobilizing agent and the amount of treatment in a hydrophobilization process. The particle size can be controlled by various factors, such as the mass ratio of alkoxysilane, ammonia, alcohol and water, reaction rate, agitation speed and feeding speed in the hydrolysis step and polycondensation step in the sol-gel process. Monodisperse and spherical particulate silica can be achieved by this technique.

### (Method of Preparing Particulate Silica by Sol-Gel Process)

The method of producing the particulate silica according to the present invention may be any known method for preparing particulate silica, in which the particulate silica of the present invention is prepared primarily through three steps of hydrolysis, condensation polymerization, and hydrophobilization in combination with other steps such as drying, if necessary.

The outline of the fabrication process of the particulate silica according to the present invention is described below. An alkoxysilane is added dropwise in a mixture of water and alcohol in the presence of a catalyst with stirring at elevated temperature. Then, the silica-sol suspension formed by the reaction is centrifugally separated into wet silica gel, alcohol, and aqueous ammonia. A solvent is added to the wet silica gel to return it to the silica sol and then the hydrophobilizing agent is added to hydrophobilize the silica surface. Alternatively, the sol is dried into dried sol followed by the addition of the hydrophobilizing to hydrophobilize the silica surface.

Examples of the hydrophobilizing agent used herein include common coupling agents, silicone oils, fatty acids, and metal salts of fatty acids. Then, the solvent is removed from the hydrophobilized silica sol, and the sol is dried to give the particulate silica according to the present invention. Furthermore, the resulting silica may be hydrophobilized again.

Other steps may be added, examples of which include a spray drying process involving spray of the silica particles suspended in a gas phase with a treating agent or a solution containing a treating agent; a wet process involving immersion of the particles in a solution containing a treating agent and then drying; and a mixing process involving mixing of the particles with a treating agent in a mixer.

Water-soluble silane compounds can be used as the hydrophobilizing agent. Such silane compounds are represented by a formula (2):

RₐSiX₄₋ₐ Formula (2)

where a is an integer of 0 to 3, R is a hydrogen atom, an organic group such as an alkyl group and alkenyl group, and X is a hydrolyzable group such as a chlorine atom, methoxy group, or ethoxy group.

Examples of the compound represented by the formula (2) include chlorosilane, alkoxysilane, silazane, and special silylation agents. More specific examples include methyltrichlorosilane, dimethyldichlorosilane, trimethylchlorosilane, phenyltrichlorosilane, diphenyldichlorosilane, tetramethoxysilane, methyltrimethoxysilane, dimethyldimethoxysilane, phenyltrimethoxysilane, diphenyldimethoxysilane, tetraethoxysilane, methyltriethoxysilane, dimethyldiethoxysilane, phenyltriethoxysilane, diphenyldiethoxysilane, isobutyltrimethoxysilane, decyltrimethoxysilane, hexamethyldisilazane, N,O-bis(trimethylsilyl)acetamide, N,N-bis(trimethylsilyl)urea, tert-butyldimethylchlorosilane, vinyltrichlorosilane, vinyltrimethoxysilane, vinyltriethoxysilane, γ-methacryloxypropyltrimethoxysilane, β-(3,4-epoxycyclohexyl)ethyltrimethoxysilane, γ-glycidoxypropyltrimethoxysilane, γ-glycidoxypropylmethyldiethoxysilane, γ-mercaptopropyltrimethoxysilane, and γ-chloropropyltrimethoxysilane.

Particularly preferred examples of the hydrophobilizing agent include dimethyldimethoxysilane, hexamethyldisilazane (HMDS), methyltrimethoxysilane, isobutyltrimethoxysilane, and decyltrimethoxysilane.

Specific examples of silicone oils include cyclic compounds such as organosiloxane oligomers, octamethylcyclotetrasiloxane, decamethylcyclopentasiloxane, tetramethylcyclotetrasiloxane, and tetravinyltetramethylcyclotetrasiloxane; and straight chain or branched chain organosiloxanes. Highly reactive silicone oils having a modified-terminal at least one end may be also used, which a modified group is introduced at one or both ends of the main chain, or one end or both ends of each side chain. Non-limiting examples of the modified group include alkoxy, carboxy, carbinol, modified higher fatty acid, phenol, epoxy, methacrylic, and amino groups. Silicone oils having two or more types of modified groups such as amino and alkoxy modified groups can be also used.

Dimethyl silicone oil may be mixed or combined with one or more of these modified silicone oils, optionally further with one or more of other surface-treating agents. Examples of the surface-treating agents used with these silicone oils include silane coupling agents, titanate coupling agents, aluminate coupling agents, various silicone oils, fatty acids, metal salts of fatty acids, esterified compounds thereof, and rosin acids.

### (Amount of Particulate Silica Added)

The amount of the added particulate silica according to the present invention is preferably in the range of 0.7 to 3.0 parts by mass relative to 100 parts by mass of the toner base particles. The amount of the particulate silica added within this range enhances the development and transfer efficiency.

### (Process of Mixing Silica Particles)

The method of adhesion of the silica particles to the surface of the toner base particles can use any conventional process of mixing external additives with the toner base particles. The method of adding the silica particles includes a dry process involving addition of powdered silica particles to dried toner base particles. Examples of the mixing machine include mechanical mixing machines such as Henschel mixers and coffee mills. Other common external additives can be added for controlling charging characteristics and fluidity as described below.

In the present invention, a mixture of a toner composed of toner base particles and the silica particles as an external additive and a carrier is preferably used as a two-component developer.

The term “toner particles” used in the present invention refers to particles formed by adding the external additive to surface of the “toner base particles”. The term “toner” refers to a mass of “toner particles”.

### (Toner Base Particles)

The toner base particles constituting the toner according to the present invention comprising a binder resin, a colorant, and a release agent, and the binder resin preferably includes a resin having a hydrophilic polar group. Examples of the process of preparing the toner base particles include a pulverization process, an emulsion polymerization aggregation process, a suspension polymerization process, a solution suspension process, and an emulsion aggregation process. The preferred process of preparing the toner base particles are an emulsion aggregation process and an emulsion polymerization aggregation process.

It is particularly preferred that the toner according to the present invention be prepared by a process of mixing a dispersion solution containing colorant microparticles dispersed in an aqueous medium and a dispersion solution containing binder resin microparticles dispersed in an aqueous medium so as to aggregate and fuse the colorant microparticles and the resin microparticles, that is, by a manufacturing process such as emulsion polymerization aggregation. This process is preferred because colorant microparticles contained in toner have excellent dispersibility in the colorant dispersion solution and the toner particles can be formed while retaining the high dispersibility even after the colorant microparticles and binder resin microparticles are aggregated and fused into toner particles.

The toner base particles according to the present invention preferably have a core-shell structure.

### (Binder Resin)

In the case where the toner is manufactured by, for example, a pulverization process, a solution suspension process, or an emulsion aggregation process, examples of the binder resin contained in the toner according to the present invention include various known resins, such as vinyl resins, e.g., styrene resins, (meth)acrylate resins, styrene-(meth)acrylate copolymers, and olefin resins; polyester resins; polyamide resins; carbonate resins; polyether resins; polyvinyl acetate resins; polysulfone resins; epoxy resins; polyurethane resins; and urea resins. These resins may be used alone or in combination thereof.

In the case where the toner is prepared by, for example, a suspension polymerization process, a emulsion polymerization aggregation process, or a mini-emulsion polymerization aggregation process, the following polymerizable monomers may be used to prepare the binder resin: styrene or styrene derivatives such as styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene; methacrylic acid ester derivatives such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate and dimethylaminoethyl methacrylate; acrylic acid ester derivatives such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate and phenyl acrylate; olefins such as ethylene, propylene and isobutylene; halogenated vinyl such as vinyl chloride, vinylidene chloride, vinyl bromide, vinyl fluoride and vinylidene fluoride; vinyl esters such as vinyl propionate, vinyl acetate and vinyl benzoate; vinyl ethers such as vinyl methyl ether and vinyl ethyl ether; vinyl ketones such as vinyl methyl ketone, vinyl ethyl ketone and vinyl hexyl ketone; N-vinyl compounds such as N-vinylcarbazole, N-vinylindole and N-vinylpyrrolidone; vinyl compounds such as vinyl naphthalene and vinyl pyridine, and vinyl monomers such as derivatives of acrylic acid and methacrylic acid such as acrylonitrile, methacrylonitrile and acrylamide. These vinyl monomers may be used alone or in combination thereof.

A polymerizable monomer containing an ionicically dissociative group is preferably used in combination with the polymerizable monomer described above for preparing the binding resin. Examples of the polymerizable monomers containing an ionicically dissociative group include those having a substituent group such as a carboxyl group, a sulfonic acid group or a phosphoric acid group as a constitutional group. Specific examples thereof include acrylic acid, methacrylic acid, maleic acid, itaconic acid, cinnamic acid, fumaric acid, monoalkyl maleates, monoalkyl itaconates, styrenesulfonic acid, allylsulfosuccinic acid, 2-acrylamido-2-methylpropanesulfonic acid, acidophosphooxyethyl methacrylate and 3-chloro-2-acid phosphooxypropyl methacrylate.

Furthermore, a cross-linked binder resin can be prepared using poly-functional vinyls such as divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentylglycol dimethacrylate and neopentylglycol diacrylate.

### (Styrene-Acrylic-Modified Polyester Resin)

In the case where the toner base particles of the toner according to the present invention have a core-shell structure, the resin forming the shell layer is preferably a styrene-acrylic-modified polyester resin. In the present invention, the term “styrene-acrylic-modified polyester resin” refers to a resin formed by bonding polyester segments composed of polyester resin and styrene-acrylic polymer segments composed of a styrene-acrylic polymer via a dual-reactive monomer. The term “styrene-acrylic polymer segment” refers to a polymer fraction prepared by polymerizing an aromatic vinyl monomer together with an acrylate monomer and/or a methacrylate monomer. The term “polyester segment” refers to a polymer fraction composed of a polyester resin.

A polyester resin has highly sharp melting characteristics while having a high glass transition temperature. The use of the polyester resin for the shell layer, therefore, allows for satisfying both temperature-resistant storage stability and low-temperature fixing ability. In the case, however, where a styrene-acrylic resin is used for a core-forming binder resin, it is difficult to form a uniform thin shell layer due to its poor affinity to a polyester resin. Accordingly, the use of a styrene-acrylic-modified polyester as a shell-forming resin increases the affinity between the core-forming styrene-acrylic resin and shell-forming styrene-acrylic-modified polyester resin, which affinity enables a thin uniform shell layer to be formed, resulting in the production of a toner excellent in temperature-resistant storage stability and low-temperature fixing ability.

The term “dual-reactive monomer” refers to a monomer having a group capable of reacting with a polyvalent carboxylic acid monomer and/or polyvalent alcohol monomer and a polymerizable unsaturated group for forming a polyester segment of the styrene-acrylic-modified polyester resin.

### (Colorant)

A colorant can be added to the toner according the present invention. Any known colorant can be used.

Specific examples of the colorant for a yellow toner includes C.I. Solvent Yellow 19, C.I. Solvent Yellow 44, C.I. Solvent Yellow 77, C.I. Solvent Yellow 79, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, and C.I. Solvent Yellow 162; C.I. Pigment Yellow 14, C.I. Pigment Yellow 17, C.I. Pigment Yellow 74, C.I. Pigment Yellow 93, C.I. Pigment Yellow 94, C.I. Pigment Yellow 138, C.I. Pigment Yellow 155, C.I. Pigment Yellow 180, and C.I. Pigment Yellow 185. These can be used alone or in combination. Among these, C.I. Pigment Yellow 74 is preferred.

The content of colorant in a yellow toner ranges from preferably 1 to 10 parts by mass, more preferably 2 to 8 parts by mass relative to 100 parts by mass of a binder resin.

Specific examples of the colorant constituting a magenta toner includes C.I. Solvent Red 1, C.I. Solvent Red 49, C.I. Solvent Red 52, C.I. Solvent Red 58, C.I. Solvent Red 63, C.I. Solvent Red 111, and C.I. Solvent Red 122; C.I. Pigment Red 5, C.I. Pigment Red 48:1, C.I. Pigment Red 53:1, C.I. Pigment Red 57:1, C.I. Pigment Red 122, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222; and mixture thereof. Among these, C.I. Pigment Red 122 is particularly preferred.

The content of colorant in a magenta toner is in the range of preferably 1 to 10 parts by mass, more preferably 2 to 8 parts by mass, relative to 100 parts by mass of a binder resin.

Examples of the colorant for a cyan toner include C.I. pigment Blue 15:3.

The content of colorant in a cyan toner is preferably 1 to 10 parts by mass, more preferably 2 to 8 parts by mass, relative to 100 parts by mass of a binder resin.

Examples of the colorant used in the black toner include carbon black, magnetic substances, and titanium black. The examples of the carbon black include channel black, furnace black, acetylene black, thermal black, and lamp black. Examples of the magnetic substance include ferromagnetic metals such as iron, nickel, and cobalt; alloys containing such ferromagnetic metals; compounds of ferromagnetic metals such as ferrite and magnetite; and alloys which exhibit ferromagnetism by heat treatment though containing no ferromagnetic metal such as alloys of manganese-copper-aluminum and manganese-copper-tin (referred to as Heusler's alloy) and chromium dioxide.

The content of colorant in a black toner is in the range of preferably 1 to 10 parts by mass, more preferably 2 to 8 parts by mass, relative to 100 parts by mass of a binder resin.

The toner according to the present invention can, if desired, contain internal additives such as charge control agents and releasing agents and other external additives other than the large-diameter silica particles.

### (Charge Controlling Agent)

Any charge controlling agent capable of providing a positive or a negative charge by friction charging can be used without limitation. Various known positive charge controlling agents and negative charge controlling agents can be used.

The content of the charge controlling agent is in the range of preferably 0.01 to 30 parts by mass and more preferably 0.1 to 10 parts by mass, relative to 100 parts by mass of a binder resin.

### (Releasing Agent)

Various types of wax may be uses as releasing agents.

Examples of the waxes include polyolefin waxes such as polyethylene wax and polypropylene wax; branched chain hydrocarbon waxes such as microcrystalline wax; long-chain hydrocarbon waxes such as paraffin wax and Sasol Wax; dialkyl ketone waxes such as distearyl ketone; ester waxes such as carnauba wax, montan wax, behenyl behenate, trimethylolpropane tribehenate, pentaerythritol tetrabehenate, pentaerythritol diacetate dibehenate, glycerin tribehenate, 1,18-octadecanediol distearate, tristearyl trimellitate, and distearyl maleate; and amide waxes such as ethylenediamine behenylamide and tristearylamide trimellitate.

The content of the releasing agent is in the range of preferably 0.1 to 30 parts by mass and more preferably 1 to 10 parts by mass relative to 100 parts by mass of the binder resin.

### (External Additive)

Any external additive other than the particulate silica according to the present invention can be added to improve the fluidity and charging property. Inorganic particles are exemplified for such external additives such as particulate inorganic oxide such as silica, alumina and titanium oxide; particulate inorganic stearate such as aluminum stearate and zinc stearate; and particulate inorganic titanate such as strontium titanate and zinc titanate.

These inorganic particles are preferably treated with a silane coupling agent, a titanate coupling agent, a higher fatty acid, or silicone oil for surface modification to enhance temperature-resistant storage stability and environmental stability.

The content of the external additives is in the range of 0.05 to 5 parts by mass, and preferably 0.1 to 3 parts by mass relative to 100 parts by mass of the toner base particles. The various combinations of the external additives may be used.

### (Processes of Manufacturing Toner Base Particles)

An emulsion polymerization aggregation process which is advantageously used for manufacturing the toner base particles according to the present invention includes steps of mixing a dispersion solution of microparticles of a binder resin prepared by an emulsion polymerization process (hereinafter, refer to as “binder resin microparticles”), a dispersion solution of microparticles of a colorant (hereinafter, refer to as “colorant microparticles”) and a dispersion solution of a releasing agent such as wax; allowing aggregation to proceed until a predetermined toner particle size is reached; and controlling the shape of the particles by fusing the binder resin microparticles.

An emulsion aggregation process which is advantageously used for manufacturing the toner base particles according to the present invention includes steps of adding dropwise a solution of a binding resin dissolved in a solvent to a poor solvent to prepare a dispersion solution of the resin particles, mixing the resin particle dispersion solution, a dispersion solution of colorants and a dispersion solution of a releasing agent such as wax, allowing aggregation to proceed until a predetermined toner particle size is reached; and controlling the shape of the particles by fusing the binder resin microparticles. In the present invention, both processes can be applied.

An emulsion polymerization aggregation process is shown below as an example of manufacturing toner base particles according to the present invention.

(1) A step of preparing a dispersion solution in which colorant microparticles are dispersed in an aqueous medium;
(2) A step of preparing a dispersion solution in which binder resin microparticles, optionally containing an internal additive, are dispersed in an aqueous medium;
(3) A step of preparing a dispersion solution of binder resin microparticles by emulsion polymerization;
(4) A step of forming toner base particles by mixing the dispersion solution of colorant microparticles and the dispersion solution of binder resin microparticles to aggregate, associate, and fuse the colorant microparticles and the binder resin microparticles;
(5) A step of filtering the dispersion system (the aqueous medium) of toner base particles to separate the toner base particles for removing, for example, a surfactant;
(6) A step of drying the toner base particles; and
(7) A step of adding an external additive to the toner base particles.

In the production of toner base particles by the emulsion polymerization aggregation process, the binder resin microparticles prepared by the emulsion polymerization process may have a multi-layered structure of two or more layers each composed of a binder resin having a different composition. The binder resin microparticles having a two-layer structure, for example, can be provided by preparing a dispersion solution of binder resin particles according to the conventional emulsion polymerization process (first stage polymerization), followed by adding a polymerization initiator and a polymerizable monomer into the dispersion solution to proceed the polymerization (second stage polymerization).

Toner base particles having a core shell structure can be prepared by the emulsion polymerization aggregation process. The toner base particles having a core shell structure can be prepared as follows. At first, core particles are prepared by aggregation, association and fusion of the binder resin particles for the core particles and the colorant particles. Then binder resin microparticles for the shell layer are added to the core particle dispersion solution so as to aggregate and fuse onto the surface of the core particles, resulting in formation of the shell layer for covering the surface of the core particles, whereby the toner base particles having the core shell structure are prepared.

A pulverization process is shown as an example of manufacturing toner base particles of the present invention.

(1) A step of mixing a binder resin, a colorant, and an internal additive as necessary with, for example, a Henschel mixer;
(2) A step of kneading the resulting mixture with, for example, an extrusion kneader with heating;
(3) A step of coarsely pulverizing the resulting kneaded material with, for example, a hammer mill, followed by further pulverizing with, for example, a turbo mill pulverizer;
(4) A step of forming toner base particles by powder classification process of the resulting pulverized material, for example, through an air sifter based on a Coanda effect; and
(5) A step of adding external additives to toner base particles.

### (Particle Diameter of Toner Particles)

The particle diameter of toner particles according to the present invention is a volume-based median diameter in the range of preferably 4 to 10 μm, and more preferably 5 to 9 μm.

The toner particles having a volume based median diameter within the above range causes high transfer efficiency and can increase half tone image quality and thus high quality image of fine lines and dots can be obtained.

The volume-based median diameter of toner particles can be determined using a device of “Multisizer 3” (Beckman Coulter Inc.) connected to a computer system (Beckman Coulter Inc.) for data processing.

### (Developer)

The toner according to the invention can be used not only as a nonmagnetic one-component developer but also used as a two-component developer by being mixed with a carrier.

Magnetic particles composed of known materials can be used as a carrier. Examples of the known materials include a ferromagnetic metal such as iron; an alloy of a ferromagnetic metal, aluminum and lead; a ferromagnetic metal compounds such ferrite and magnetite. In particular, the ferrite particle is most preferred. Examples of the usable carrier include a coated carrier composed of the magnetic particle coated with a coating material such as a resin; and a binder-type carrier composed of binder resin containing dispersed magnetic particles. Examples of the coating resin building up the coated carrier include, but are not limited to, olefin resins, styrene resins, styrene-acryl resins, silicone resins, ester resins and fluorine resins. Examples of the resins composing the resin dispersion-type carrier include, but are not limited to, known resins such as styrene-acrylic resins, polyester resins, fluorine resins and phenol resins.

The volume-based median diameter of the carrier is in the range of preferably 20 to 100 μm, and more preferably 20 to 60 μm.

The volume-based median diameter of the carrier can be typically determined with a laser diffraction particle size distribution analyzer provided with a wet type disperser, “HELOS & RODOS” (manufactured by Sympatec GmbH).

### (Method for Forming Electrophotographic Image)

The method for forming an electrophotographic image of the present invention includes the following steps.

(1) A step of charging a surface of an organic photoreceptor by a charging unit (charging step);
(2) A step of electrostatically forming an electrostatic latent image on the organic photoreceptor by an exposing unit (exposing step);
(3) A step of developing the electrostatic latent image into a visible toner image by a developing unit (developing step);
(4) A step of transferring the toner image to a transfer medium such as a paper sheet by a transferring unit (transferring step);
(5) A step of fixing the toner image transferred on the transfer medium through a fixing treatment of a contact heating process (fixing step); and
(6) A step of cleaning the surface of the organic photoreceptor by a cleaning unit (cleaning step).

The above steps provide a visible image on the transfer medium and the method is suitably applied to a device for forming an electrophotographic image.

### (Device for Forming Electrophotographic Image)

A device for forming an electrophotographic image according to the present invention will now be described below.

The device for forming an electrophotographic image according to the present invention includes (1) an organic photoreceptor, (2) a charging unit for charging the surface of the organic photoreceptor, (3) an exposing unit for forming an electrostatic latent image by image exposure on the surface of the organic photoreceptor charged by the charging unit, (4) a developing unit for forming a toner image by visualizing the electrostatic latent image formed by the exposing unit, (5) a transferring unit for transferring the toner image on the surface of the organic photoreceptor formed by the developing unit onto a transfer medium such as a paper sheet or a transfer belt, and (6) a cleaning unit for cleaning the surface of the organic photoreceptor by contacting with the organic receptor.

The preferred charging unit for charging the electrophotographic photoreceptor is a non-contact charging device. Examples of the non-contact charging device include corona charging devices, corotron charging devices and scorotron charging devices.

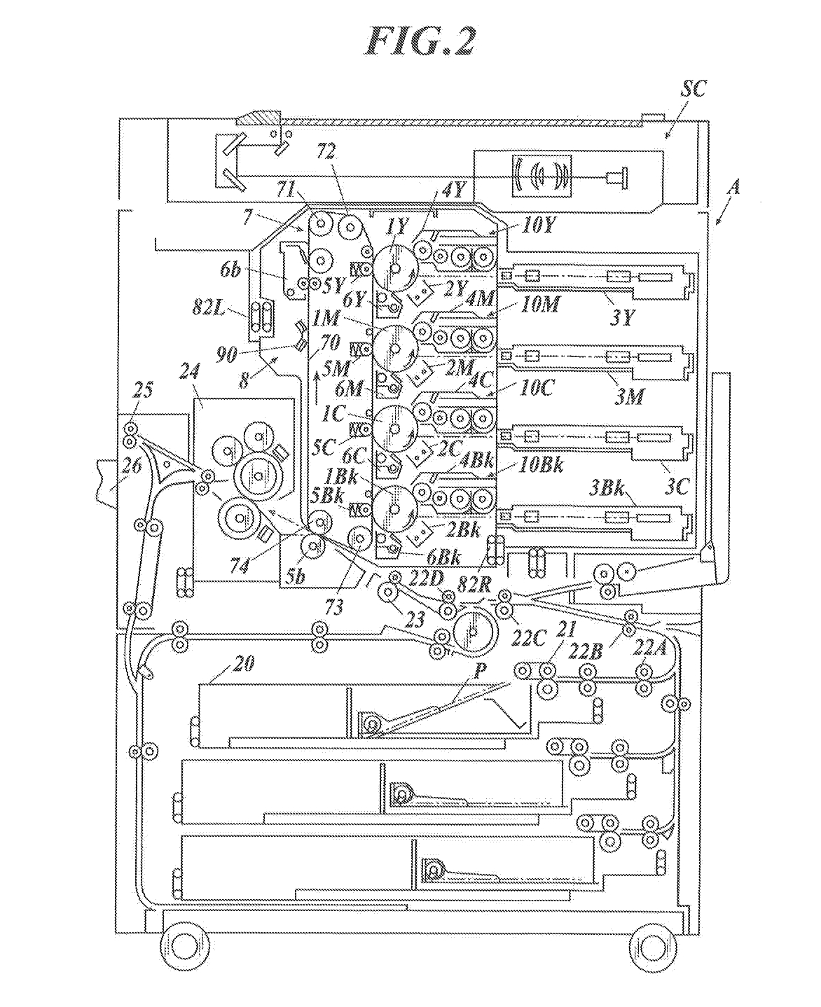

FIG. 2 is a schematic view illustrating a device for forming a color electrophotographic image according to an embodiment of the present invention.

The device for forming an electrophotographic color image is termed a “tandem-type color image forming device”, and includes four sets of image forming units 10Y, 10M, 10C, and 10Bk, endless-belt intermediate transfer unit 7, a sheet feeding and conveyance device 21 and a fixing device 24. A body A of the image forming device is provided with a document reader SC on the top thereof.

The image forming unit 10Y that forms images of yellow color includes a charging unit (charging step) 2Y, an exposing unit (exposing step) 3Y, a developing unit (developing step) 4Y, a primary transfer roller 5Y as a primary transfer unit (primary transfer step), and a cleaning unit 6Y all placed around the cylindrical photoreceptor 1Y which acts as a first image carrier. The image forming unit 10M that forms images of magenta color includes a cylindrical photoreceptor 1M which acts as a first image carrier, a charging unit 2M, an exposing unit 3M, a developing unit 4M, a primary transfer roller 5M as a primary transfer unit, and a cleaning unit 6M. The image forming unit 10C that forms images of cyan color includes a cylindrical photoreceptor 1C which acts as a first image carrier, a charging unit 2C, an exposing unit 3C, a developing unit 4C, a primary transfer roller 5C as a primary transfer unit, and a cleaning unit 6C. The image forming unit 10Bk that forms images of black color includes a cylindrical photoreceptor 1Bk which acts as a first image carrier, a charging unit 2Bk, an exposing unit 3Bk, a developing unit 4Bk, a primary transfer roller 5Bk as a primary transfer unit, and a cleaning unit 6Bk.

The four sets of image forming units 10Y, 10M, 10C, and 10Bk, respectively, are composed of the centrally-located photosensitive drums 1Y, 1M, 1C, and 1Bk, the charging unit 2Y, 2M, 2C, and 2Bk, the image exposing unit 3Y, 3M, 3C, and 3Bk, the developing unit 4Y, 4M, 4C, and 4Bk, and the cleaning unit 6Y, 6M, 6C, and 6Bk that clean the photosensitive drums 1Y, 1M, 1C, and 1Bk.

The image forming units 10Y, 10M, 10C, and 10Bk have the same configuration except that toner images of different colors are formed on the respective photosensitive drums 1Y, 1M, 1C, and 1Bk, and the image forming unit 10Y will now be described in detail as a representative thereof.

The image forming unit 10Y includes a charging unit 2Y (hereinafter referred to simply as the charging unit 2Y or the charger 2Y), the exposing unit 3Y, the developing unit 4Y, and the cleaning unit 6Y (hereinafter referred to simply as the cleaning unit 6Y or as the cleaning blade 6Y), around the photosensitive drum 1Y which is an image forming unit, and forms yellow (Y) toner image on the photosensitive drum 1Y.

Furthermore, in the present embodiment, at least the photosensitive drum 1Y, the charging unit 2Y, the developing unit 4Y, and the cleaning unit 6Y are integrated among parts of the image forming unit 10Y.

The charging unit 2Y applies a uniform electric potential to the photosensitive drum 1Y, and a charger unit 2Y of a corona discharge type is used for the photosensitive drum 1Y in the present embodiment.

The image exposing unit 3Y exposes the photosensitive drum 1Y to which a uniform potential has been applied by the charger unit 2Y with light based on the image signal (yellow), and forms the electrostatic latent image corresponding to the yellow color image. Examples of the exposing unit 3Y include an array of light emitting devices (LEDs) and imaging elements (Selfoc (trademark) lenses) arranged in the axial direction of the photosensitive drum 1Y or a laser optical system.

In the image forming device of the present invention, the structural elements, i.e., the above photoreceptor, the developing device, the cleaning device may be integrated into a single unit as a process cartridge (image forming unit) and this image forming unit may be configured to be detachably mounted in the image forming device. Alternatively, at least one of the charger unit, the image exposing device, the developing device, the transfer or separating device, and the cleaning device can be supported together with the photoreceptor to form a process cartridge (image forming unit) as a single detachable image forming unit, which may be detachable from the image firming device by a guiding means such as a rail.

The intermediate image transfer unit 7 in the shape of an endless belt has an endless intermediate image transfer belt 70 acting as a second image carrier in the shape of a semiconducting endless belt which is wound around a plurality of rollers and rotatably supported.

Color images formed by the image forming units 10Y, 10M, 10C, and 10Bk are successively transferred onto the rotating endless intermediate image transfer belt 70 by the primary transfer rollers 5Y, 5M, 5C, and 5Bk acting as the primary image transfer unit, thereby forming a combined color image. A transfer material P as a transfer medium (a support that carries the final fixed image, e.g., plain paper and transparent sheet) stored inside a sheet feeding cassette 20 is fed from the sheet feeding unit 21, passes through a plurality of intermediate rollers 22A, 22B, 22C, and 22D, and a resist roller 23, and is transported to a secondary transfer roller 5b which functions as a secondary image transfer unit. The color image is then transferred onto the transfer material P in a single secondary image transfer process. The transfer material P on which the color images have been transferred is fixed by the fixing unit 24, and is nipped by the sheet discharge rollers 25 to be placed on the sheet discharge tray 26 outside the device. The transfer support of the toner image formed on the photoreceptor such as the intermediate transfer belt and the transfer material are comprehensively referred to as transfer media.

After the color image is transferred onto the transfer material P by the secondary transfer roller 5b functioning as the secondary transfer unit, the transfer material P is separated from the endless intermediate image transfer belt 70 by different radii of curvature and the toner remaining on the endless intermediate image transfer belt 70 is removed by the cleaning unit 6b.

The primary transfer roller 5Bk constantly keeps in contact with the photoreceptor 1Bk during an image forming process. The other primary transfer rollers 5Y, 5M and 5C come into contact with corresponding photoreceptors 1Y, 1M and 1C, respectively, only during color image formation.

The secondary transfer roller 5b comes into contact with the endless intermediate transfer belt 70 only when the transfer material P passes through the roller 5b for secondary transfer.

Furthermore, a casing 8 can be pulled out through the supporting rails 82L and 82R from the body A of the device.

The casing 8 includes the image forming units 10Y, 10M, 10C, and 10Bk, and the endless-belt intermediate image transfer unit 7.

The image forming units 10Y, 10M, 10C, and 10Bk are disposed in the vertical direction. The endless-belt intermediate image transfer unit 7 is placed on the left of the photoreceptors 1Y, 1M, 1C, and 1Bk in the drawing. The endless-belt intermediate image transfer unit 7 includes the endless intermediate image transfer belt 70 that is wound and can rotate around the rollers 71, 72, 73, and 74, the primary image transfer rollers 5Y, 5M, 5C, and 5Bk, and the cleaning unit 6b.

### EXAMPLES

The present invention will be described in detail with reference to examples, but the present invention should not be limited thereto.

### (Preparation of Silica Particles)

### (1. Preparation of Monodisperse Spherical Silica A)

(1) A 3-liter reactor equipped with a stirrer, a dropping funnel, and a thermometer was charged with 630 parts by mass of methanol and 90 parts by mass of water followed by mixing. In the agitated solution, 650 parts by mass of tetramethoxysilane was hydrolyzed to yield a suspension of silica particles. The suspension was then heated to 60 to 70° C. to distill off 390 parts of methanol to give an aqueous suspension of silica particles.
(2) To the aqueous suspension, 9.4 parts by mass of methyltrimethoxysilane (0.1 in molar ratio to tetramethoxysilane) was added dropwise at room temperature to surface-treat the silica particles.
(3) Then, 1400 parts by mass of methyl isobutyl ketone was added to the thus obtained dispersion solution, which was then heated to 80° C. to distill off methanol and water. To the resulting dispersion solution, 200 parts by mass of hexamethyldisilazane was added at room temperature, followed by heating to 120° to react for 3 hr, yielding trimethylsilylated silica particles. The solvent was then evaporated under reduced pressure to prepare “monodisperse spherical silica A.”

The values of the sphericity, number-average primary particle diameter, and standard deviation of the resulting monodisperse spherical silica A were determined according to the method described above. The determined values for the monodisperse spherical silica A were as follows: sphericity Ψ=0.89 and number-average primary particle diameter=60 nm (standard deviation was 13 nm).

### (2. Preparation of Monodisperse Spherical Silica B)

Monodisperse spherical silica B was prepared in the same manner as that of the monodisperse spherical silica A except that the amount of tetramethoxysilane was changed to 700 parts by mass and the amount of hexamethyldisilazane was changed to 200 parts by mass. The characteristics of the monodisperse spherical silica B was: sphericity Ψ=0.90 and number-average primary particle diameter=70 nm (standard deviation=12 nm).

### (3. Preparation of Monodisperse Spherical Silica C)

Monodisperse spherical silica C was prepared in the same manner as that of the monodisperse spherical silica A except that the amount of tetramethoxysilane was changed to 800 parts by mass and the amount of hexamethyldisilazane was changed to 240 parts by mass. The characteristics of the monodisperse spherical silica C was: sphericity Ψ=0.90 and number-average primary particle diameter=80 nm (standard deviation=12 nm).

### (4. Preparation of Monodisperse Spherical Silica D)

Monodisperse spherical silica D was prepared in the same manner as that of the Monodisperse spherical silica A except that the amount of tetramethoxysilane was changed to 950 parts by mass and the amount of hexamethyldisilazane was changed to 280 parts by mass. The characteristics of the monodisperse spherical silica D was: sphericity Ψ=0.88 and number-average primary particle diameter=100 nm (standard deviation=20 nm).

### (5. Preparation of Monodisperse Spherical Silica E)

Monodisperse spherical silica E was prepared in the same manner as that of the monodisperse spherical silica A except that the amount of tetramethoxysilane was changed to 1200 parts by mass and the amount of hexamethyldisilazane was changed to 360 parts by mass. The characteristics of the monodisperse spherical silica E was: sphericity Ψ=0.87 and number-average primary particle diameter=120 nm (standard deviation=24 nm).

### (6. Preparation of Monodisperse Spherical Silica F)

Monodisperse spherical silica F was prepared in the same manner as that of the monodisperse spherical silica A except that the amount of tetramethoxysilane was changed to 1500 parts by mass and the amount of hexamethyldisilazane was changed to 500 parts by mass. The characteristics of the monodisperse spherical silica F was: sphericity Ψ=0.84 and number-average primary particle diameter=150 nm (standard deviation=31 nm).

### (7. Preparation of Monodisperse Spherical Silica G)

Monodisperse spherical silica G was prepared in the same manner as that of the Monodisperse spherical silica A except that the amount of tetramethoxysilane was changed to 1600 parts by mass and the amount of hexamethyldisilazane was changed to 520 parts by mass. The characteristics of the monodisperse spherical silica G was: sphericity Ψ=0.87 and number-average primary particle diameter=160 nm (standard deviation=25 nm).

### (Preparation of Surface-Treated Particles)

### (Preparation of Surface-Treated Metal Oxide Particles 1)

Tin oxide particles (manufactured by CIK NanoTek Corporation) having a number-average primary particle diameter of 21 μm (used as metal oxide particles) was subjected to a surface-treatment with an exemplary compound (S-15) (used as a compound having a radical polymerizable functional group) in the following manner.

A mixture of tin oxide particles (100 parts by mass), exemplary compound (S-15) (30 parts by mass) and a mixed solvent of toluene/2-propanol=1/1 (mass ratio) (300 parts by mass) was placed in a sand mill together with zirconia beads and was agitated at a rotational rate of 1500 rpm at about 40° C. The tin oxide particles were thus surface-treated with a compound having a radical polymerizable functional group (exemplary compound 5-15). Then, the treated mixture was transferred from the sand mill into a Henschel mixer and agitated for 15 min at a rotational rate of 1500 rpm. Then, the resulting mixture was dried at 120° C. for 3 hr to complete the surface-treatment of the tin oxide particles with the compound having the radical polymerizable functional group to prepare “surface-treated metal oxide particles 1.” The surface of the tin oxide particles was found to be covered with exemplary compound (S-15) having the radical polymerizable functional group by the surface-treatment.

### (Preparation of Surface-Treated Metal Oxide Particles 2)

Surface-treated metal oxide particles 2 were prepared in the same manner as that of the surface-treated metal oxide particles 1 except that “alumina particles” having a number-average primary particle diameter of 30 nm were used as metal oxide particles and “exemplary compound (S-15)” was used as a surface-treating agent.

### (Preparation of Surface-Treated Metal Oxide Particles 3)

Surface-treated metal oxide particles 3 were prepared in the same manner as that of the surface-treated metal oxide particles 1 except that “titanium oxide particles” having a number-average primary particle diameter of 6 nm were used as metal oxide particles and “exemplary compound (S-15)” was used as a surface-treating agent.

### (Preparation of Surface-Treated Metal Oxide Particles 4)

Surface-treated metal oxide particles 4 were prepared in the same manner as that of the surface-treated metal oxide particles 1 except that “silica particles” having a number-average primary particle diameter of 50 nm were used as metal oxide particles and “hexamethyldisilazane” was used as a surface-treating agent.

The surface-treated metal oxide particles prepared above are summarized in Table 1.

TABLE 1

| SURFACE- | METAL OXIDE PARTICLES | | |
|---|---|---|---|
| TREATED | | NUMBER-AVERAGE | SURFACE- |
| METAL OXIDE | | PRIMARY PARTICLE | TREATING |
| PARTICLES NO. | TYPE | DIAMETER [nm] | AGENT |
| 1 | TIN OXIDE | 21 | S-15 |
| 2 | ALUMINA | 30 | S-15 |
| 3 | TITANIUM | 6 | S-15 |
| | OXIDE | | |
| 4 | SILICA | 50 | HEXA- |
| | | | METHYL- |
| | | | DISIL- |
| | | | AZEANE |

### (Preparation of Photoreceptor)

### (Preparation of Photoreceptor 1)

Photoreceptor 1 was prepared as described below.

The surface of a cylindrical aluminum support with a diameter of 60 mm was subjected to a cutting process to prepare a conductive support having a fine surface roughness.

### (Intermediate Layer)

A dispersion liquid having the following composition was diluted to two-fold with the same solvent and the diluted dispersion solution was filtered after standing overnight (filter: Ridimesh 5 μm filter produced by Japan Pall Ltd.) to prepare an interlayer coating composition.

| | |
|---|---|
| Polyamide resin (CM8000: manufactured, | 1 part by mass |
| by Toray Industries, Inc.) | |
| Titanium oxide (SMT500SAS: manufactured | 3 parts by mass |
| by TAYCA Corporation) | |
| Methanol | 10 parts by mass |

The liquid was dispersed in a batch process for 10 hours by a sand mill.

The coating liquid was applied onto the support by a dipping coating process so as to prepare an intermediate layer having a dry thickness of 2 μm.

### (Charge Generation Layer)

| | |
|---|---|
| Charge generation material: Pigment (CG-1): | 20 parts by mass |
| a mixed crystal of a 1:1 adduct of titanyl | |
| phthalocyanine and (2R,3R)-2,3-butanediol and | |
| a non-adduct titanyl phthalocyanine | |
| Polyvinyl butyral resin (#6000-C: | 10 parts by mass |
| manufactured by DENKI KAGAKU KOGYO K.K.) | |
| t-butyl acetate | 700 parts by mass |
| 4-methoxy-4-methyl-2-pentanone | 300 parts by mass |

The above components were mixed and dispersed by an ultrasonic disperser for 10 hr to prepare a coating solution for a charge generation layer. The coating solution was coated on the intermediate layer by a dipping coating process to form a charge generation layer having a dry thickness of 0.3 μm.

CG-1 was synthesized as follows.

### Synthesis Example 1

### Synthesis of Pigment CG-1

### (1) Synthesis of Amorphous Titanyl Phthalocyanine

In ortho-dichlorobenzene (200 parts by mass), 1,3-diiminoisoindoline (29.2 parts by mass) was dispersed, and then titanium tetra-n-butoxide (20.4 parts by mass) was added, followed by heating for 5 hr at 150 to 160° C. in nitrogen atmosphere. After air cooling, a precipitated crystal was separated by filtering and was washed with chloroform and then with an aqueous 2% hydrochloric acid solution, followed by washing with water then methanol, and drying to give crude titanyl phthalocyanine (26.2 parts by mass, yield: 91%).

The crude titanyl phthalocyanine was dissolved in concentrated sulfuric acid (250 parts by mass) with stirring at 5° C. or less for 1 hr and then the mixture was poured into water (5,000 parts by mass) of 20° C. The precipitated crystal was filtered and sufficiently washed with water to give a wet paste product (225 parts by mass).

The wet paste product was then frozen in a freezer and then the product was melted, followed by filtration and drying to give amorphous titanyl phthalocyanine (24.8 parts by mass, yield: 86%).

(2) Synthesis of Adduct of Titanyl Phthalocyanine and (2R,3R)-2,3-butanediol (CG-1)

The above amorphous titanyl phthalocyanine (10.0 parts by mass) and (2R,3R)-2,3-butanediol (0.94 parts by mass, molar ratio=0.6 where the molar ratio is relative to titanyl phthalocyanine, hereinafter, the same definition holds) were mixed into o-dichlorobenzene (ODB) (200 parts by mass) and then stirred with heating at 60 to 70° C. for 6 hr. After being left standing overnight, methanol was added to the reaction mixture and formed crystals were separated by filtering and washed with methanol to give CG-1 (pigment containing an adduct of titanyl phthalocyanine and (2R,3R)-2,3-dutanediol) (10.3 parts by mass). The X-ray diffraction spectrum of CG-1 had clear peaks at 8.3°, 24.7°, 25.1°, and 26.5°. The mass spectrum showed peaks at 576 and 648. The IR spectrum showed absorptions of Ti═O and O—Ti—O around 970 cm⁻¹ and around 630 cm⁻¹, respectively. Furthermore, the thermogravimetry (TG) showed a mass decrease of about 7% occurring at 390 to 410° C. These results demonstrate that the product is probably a mixed crystal of a 1:1 adduct of titanyl phthalocyanine and (2R,3R)-2,3-butanediol and a non-adduct (non-added) titanyl phthalocyanine.

The BET specific surface area of the CG-1 was determined to be 31.2 m²/g by an automatic flow specific surface area analyzer (Micrometrics Flowsoap type, manufactured by Shimadzu Corp.).

### (Charge Transport Layer)

| | | |
|---|---|---|
| Charge transport material | 225 | parts by mass |
| (Compound A described below) | | |
| Polycarbonate resin (Iupilon Z300: | 300 | parts by mass |
| manufactured by Mitsubishi Gas | | |
| Chemical Co., Inc.) | | |
| Antioxidant (BHT) | 20 | parts by mass |
| Tetrahydrofuran (THF) | 1,600 | parts by mass |
| Toluene | 400 | parts by mass |
| Silicone oil (KF-96: manufactured | 1 | part by mass |
| by Shin-Etsu Chemical Co., Ltd.) | | |

The above components were mixed and the mixture was dissolved to prepare a coating solution for charge transport layers.

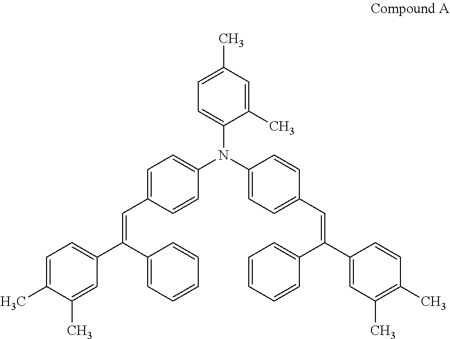

The coating solution was applied onto a charge generation layer by a circular slide hopper coater and was dried at 120° C. for 70 min to form a charge transport layer having a dry thickness of 24 μm.

### (Protective Layer)

A protective layer was formed in the following manner.

| | | |
|---|---|---|
| Surface-treated metal oxide particles 1 | 80 | parts by mass |
| (tin oxide surface-treated with S-15) | | |
| Polymerizable compound | 100 | parts by mass |
| (exemplary compound M1) | | |
| Charge transport material (exemplary | 25 | parts by mass |
| compound CTM-13) | | |
| Polymerization initiator (Irgacure 819: | 8 | parts by mass |
| manufactured by BASF Japan Ltd.) | | |
| 2-Butanol | 360 | parts by mass |
| Tetrahydrofuran (THF) | 40 | parts by mass |

A mixture of the surface-treated metal oxide particles 1 (tin oxide surface-treated with S-15), polymerizable compound and 2-butanol was dispersed by a ultrasonic homogenizer “US-600T” (manufactured by Nissei Corporation) and the dispersion solution was mixed with the other materials to prepare a coating solution for the protective layer. The coating solution was applied with a circular slide hopper coater onto the charge transport layer preliminarily formed on the photoreceptor. The coated surface was irradiated with ultraviolet light using a xenon lamp for one minute to form a protective layer having a thickness of 2.5 μm, followed by drying for 70 min at 80° C. to prepare Photoreceptor 1.

CTM-13 is synthesized as follows.

### Synthesis Example 2

### Synthesis of CTM-13

Copper(I) iodide (0.52 g: 2.7 mmol), 1,10-phenanthroline monohydrate (1.08 g: 5.5 mmol) and xylene (10 mL) were added into a four-necked flask equipped with a condenser under a nitrogen stream, followed by stirring for 30 min at 60° C. Then, 4-methyl diphenylamine (5.00 g: 27.3 mmol), 4-iodo-4′-n-propyl biphenyl (9.01 g: 32.8 mmol), sodium tert-butoxide (3.28 g: 34.1 mmol), and xylene (20 mL) were added and the mixture was refluxed for 6 hr at 130° C. After air cooling, water (100 mL) was added to the mixture followed by stirring for 30 min and the resulting organic layer was washed with water until the aqueous layer became neutral. The organic layer was dried over sodium sulfate, followed by distilling off the toluene.

The crude product was purified through a silica gel column (developing solvent: n-heptane/toluene=1/1) to give exemplary compound (CTM-13) (7.52 g, yield: 73%).

### (Preparation of Photoreceptors 2 to 8)

Photoreceptors 2 to 8 were prepared in the same manner as the Photoreceptor 1 except that the metal oxide particles, the surface-treating agent, the polymerizable compound, and the charge transport material in the protective layer were changed as shown in Table 2.

### (Preparation of Photoreceptor 9)

Photoreceptor 9 was prepared in the same manner as the Photoreceptor 1 except that a polycarbonate resin (Iupilon Z300: manufactured by Mitsubishi Gas Chemical Co., Inc.) was used in place of the polymerizable compound in the protective layer and that the metal oxide particles, the surface-treating agent and the charge transport material in the protective layer were changed as shown in Table 2.

TABLE 2

| | POLYMERIZABLE | | SURFACE-TREATED | | | | | CHANGE TRANSPORT | |
|---|---|---|---|---|---|---|---|---|---|
| | COMPOUND | | METAL OXIDE PARTICLES | | | | | MATERIAL | |
| | EXEMPLARY | AMOUNT | | | | SURFACE- | AMOUNT | EXEMPLARY | AMOUNT |
| PHOTORECEPTOR | COMPOUND | (PARTS BY | | | *PARTICLE | TREATING | (PARTS | COMPOUND | (PARTS |
| NO. | NO. | MASS) | NO. | TYPE | SIZE [NM] | AGENT | BY MASS) | NO. | BY MASS) |
| PHOTORECEPTOR 1 | M1 | 100 | 1 | TIN OXIDE | 21 | S-15 | 80 | CTM-13 | 25 |
| PHOTORECEPTOR 2 | M1 | 100 | 2 | ALUMINA | 30 | S-15 | 200 | CTM-13 | 15 |
| PHOTORECEPTOR 3 | M1 | 100 | 3 | TITANIUM | 6 | S-15 | 100 | CTM-13 | 20 |
| | | | | OXIDE | | | | | |
| PHOTORECEPTOR 4 | M1 | 100 | 1 | TIN OXIDE | 21 | S-15 | 80 | CTM-11 | 25 |
| PHOTORECEPTOR 5 | M1 | 100 | 1 | TIN OXIDE | 21 | S-15 | 80 | CTM-5 | 25 |
| PHOTORECEPTOR 6 | M1 | 100 | 1 | TIN OXIDE | 21 | S-15 | 80 | CTM-7 | 25 |
| PHOTORECEPTOR 7 | M1 | 100 | 1 | TIN OXIDE | 21 | S-15 | 80 | CTM-13 | 20 |
| PHOTORECEPTOR 8 | M1 | 100 | 1 | TIN OXIDE | 21 | S-15 | 150 | — | — |
| PHOTORECEPTOR 9 | Z300 | 100 | 4 | SILICA | 50 | 1 | 20 | COMPOUND | 50 |
| | | | | | | | | A | |

Z300: POLYCARBONATE RESIN (IUPILON Z300: MANUFACTURED BY MITSUBISHI GAS CHEMICAL CO., INC.)
1: HEXAMETHYLDISILAZANE
*PARTICLE SIZE = NUMBER-AVERAGE PRIMARY PARTICLE DIAMETER

### (Preparation of Toner)

### (Preparation of Toner Base Particles)

### (Preparation of Toner Base Particles (1))

### (1) Preparation Process of Dispersion Solution of Resin Microparticles for Core

### (1-1) First-Stage Polymerization

A reactor equipped with a stirrer, a temperature sensor, a temperature controlling device, a condenser tube, and a nitrogen inlet device was charged in advance with an anionic surfactant solution, in which an anionic surfactant sodium lauryl sulfate (2.0 parts by mass) was dissolved in ion-exchanged water (2,900 parts by mass), and an internal temperature was raised to 80° C. with stirring at a stirring rate of 230 rpm under a nitrogen stream.

After a polymerization initiator, potassium persulfate (KPS) (9.0 parts by mass) was added to the anionic surfactant solution, the internal temperature was controlled to 78° C., and a monomer solution (1) composed of:

| | | |
|---|---|---|
| styrene | 540 | parts by mass, |
| n-butyl acrylate | 154 | parts by mass, |
| methacrylic acid | 77 | parts by mass, and |
| n-octylmercaptan | 17 | parts by mass |

was added dropwise over 3 hr. After the dropping, the system was heated and stirred over 1 hr at 78° C. to promote polymerization (first-stage polymerization) to prepare a dispersion solution of “Resin Microparticles (a1)”.

### (1-2) Second-Stage Polymerization: Formation of Intermediate Layer

Within a flask equipped with a stirrer, paraffin wax (melting point: 73° C.) (51 parts by mass) as an offset preventive was added to a solution composed of:

| | | |
|---|---|---|
| Styrene | 94 | parts by mass, |
| n-butyl acrylate | 27 | parts by mass, |
| methacrylic acid | 6 | parts by mass, and |
| n-octylmercaptan | 1.7 | parts by mass, |

and the solution was heated to 85° C. and dissolved to prepare a monomer solution (2).

Meanwhile, a surfactant solution of an anionic surfactant, in which sodium lauryl sulfate (2 parts by mass) was dissolved in ion-exchanged water (1,100 parts by mass), was heated to 90° C., the dispersion of Resin Microparticles (a1) (28 parts by mass as a solid content of the Resin Microparticles (a1)) was added to the surfactant solution, and the monomer solution (2) was then mixed and dispersed for 4 hr by a mechanical dispersing machine “CLEARMIX” (manufactured by M TECHNIQUE CO., Ltd.) having a circulating path to prepare a dispersion solution containing emulsified particles having a dispersion particle size of 350 nm. An aqueous initiator solution of a polymerization initiator “KPS” (2.5 parts by mass) dissolved in ion-exchanged water (110 parts by mass) was added into the dispersion solution, and the system was heated and stirred over 2 hr at 90° C. to promote polymerization (second-stage polymerization) to prepare a dispersion solution of Resin Microparticles (all).

### (1-3) Third-Stage Polymerization: Formation of Outer Layer (Preparation of Resin Microparticles (A) for Core)

A solution of a polymerization initiator “KPS” (2.5 parts by mass) in 110 parts by mass of ion-exchanged water was added to the dispersion of Resin Microparticles [a11], and a monomer solution (3) composed of:

| | | |
|---|---|---|
| styrene | 230 | parts by mass, |
| n-butyl acrylate | 78 | parts by mass, |
| methacrylic acid | 16 | parts by mass, and |
| n-octylmercaptan | 4.2 | parts by mass |

was added dropwise over 1 hr at a temperature of 80° C. After the dropping, the system was heated and stirred over 3 hr for third-stage polymerization, followed by cooling to 28° C. to prepare a dispersion solution of “Resin Microparticles (A) for core” in the anionic surfactant solution.

The “Resin Microparticles (A) for core” had a glass transition point of 45° C. and a softening point of 100° C.

### (2) Preparation Process of Dispersion Solution of Resin Microparticles (B) for Shell Layer

### (2-1) Synthesis of Resin for a Shell Layer (Styrene-Acrylic-Modified Polyester Resin (B))

A 10-liter four-necked flask equipped with a nitrogen inlet tube, a dehydrator tube, a stirrer, and a thermocouple was charged with

| | | |
|---|---|---|
| propylene oxide (2 mol) adduct of | 500 | parts by mass, |
| bisphenol A | | |
| terephthalic acid | 117 | parts by mass, |
| fumaric acid | 82 | parts by mass, and |
| esterification catalyst (tin octylate) | 2 | parts by mass, |

and polycondensation was conducted for 8 hr at 230° C. and then for 1 hr under 8 kPa. The system was then cooled to 160° C., and a mixture composed of:

| | | |
|---|---|---|
| acrylic acid | 10 | parts by mass, |
| styrene | 30 | parts by mass, |
| butyl acrylate | 7 | parts by mass, and |
| polymerization initiator | 10 | parts by mass, |
| (di-t-butyl peroxide) | | |

was then added dropwise over 1 hr through a dropping funnel. After the dropping, addition polymerization was continued for 1 hr at 160° C., and the system was then maintained at 200° C. for 1 hr under 10 kPa. Then, residual unreacted acrylic acid, styrene, and butyl acrylate were removed to give “Styrene-acryl-modified polyester resin (B).”

The “Styrene-acryl-modified polyester resin (B)” had a glass transition point of 60° C. and a softening point of 105° C.

### (2-2) Preparation of Dispersion Solution of Resin Microparticles (B) for Shell Layer

The resulting styrene-acryl-modified polyester resin (B) (100 parts by mass) was pulverized by a roundel mill model RM (manufactured by TOKUJU CO., LTD.), mixed with a 0.26 mass % solution of sodium lauryl sulfate (638 parts by mass) prepared in advance, and ultrasonically dispersed for 30 min at “V-LEVEL” and 300 μA with an ultrasonic homogenizer “US-150T” (manufactured by NISSEI Corporation) with stirring to prepare a dispersion solution of “Resin Microparticles (B) for shell layer” having a volume-based median diameter (D₅₀) of 250 nm.

### (3) Step of Preparing Dispersion Solution (1) of Colorant Microparticles

Sodium dodecyl sulfate (90 parts by mass) was stirred and dissolved in ion-exchanged water (1,600 parts by mass), carbon black “MOGUL L” (product of Cabot Corporation) (420 parts by mass) was gradually added to the solution with stirring and the mixture was dispersed by an agitator “CLEARMIX” (manufactured by M TECHNIQUE CO., LTD.) to prepare “dispersion solution (1) of colorant microparticles” containing colorant microparticles dispersed therein. The size of the colorant particles in the dispersion was determined to be 117 nm with a Microtrac particle size distribution analyzer “UPA-150” (manufactured by Nikkiso Co., Ltd.).

### (4) Preparation of Toner Base Particles (1) (Aggregation, Fusion-Washing-Drying)

A reactor equipped with a stirrer, a temperature sensor and a condenser tube was charged with the dispersion solution of “Resin Microparticles (A) for core” (288 parts by mass as a solid content) and ion-exchanged water (2,000 parts by mass), and a 5 mol/L aqueous sodium hydroxide solution was added so as to adjust the pH of the dispersion solution to 10 (at 25° C.).

Subsequently, the “dispersion solution (1) of colorant microparticles” (40 parts by mass as a solid content) was poured, and a solution of magnesium chloride (60 parts by mass) dissolved in ion-exchanged water (60 parts by mass) was then added over 10 min at 30° C. under stirring. After being left standing for 3 min, the system was raised to 80° C. over 60 min and a particle growth reaction was continued with maintaining the temperature at 80° C. In this state, the size of core particles was measured using “Coulter Multisizer 3” (manufactured by Coulter Beckmann Inc.) and a dispersion solution of the “resin particles (B) for a shell layer” (72 parts by mass as a solid content) was poured over 30 min at the time when the volume-based median diameter (D₅₀) of the core particles reached 6.0 μm, and an aqueous solution of sodium chloride (190 parts by mass) dissolved in ion-exchanged water (760 parts by mass) was added to stop the growth of the particles at the time when a supernatant liquid of the reaction system became transparent. The temperature of the reaction system was further raised, and stirring were conducted at 90° C. for allowing the fusion of the particles to proceed. At the time when the average sphericity of the particles measured with an average sphericity measuring device FPIA-2100 (manufactured by Sysmex Corporation) for toner reached 0.945 (HPF-detected number: 4,000 particles), the system was cooled to 30° C. to give a dispersion solution of “toner base particles (1)”.

The dispersion solution of the “toner base particles (1)” was subjected to solid-liquid separation with a centrifugal separator to form wet cake of the toner particles, and this cake was washed with ion-exchanged water of 35° C. with the centrifugal separator until the conductivity of the filtrate reached 5 μS/cm. The cake was then transferred to “Flash Jet Dryer” (manufactured by SEISHIN ENTERPRISE CO., Ltd.) and was dried into a water content of 0.5 mass % to give “toner base particles (1).”

### (Preparation of Toner Base Particles (2))

### (1) Step of Preparing Resin Particles (C) for a Shell Layer

A reactor equipped with a stirrer, a temperature sensor, a temperature controlling device, a condenser tube, and a nitrogen inlet device was charged in advance with a solution of an anionic surfactant (sodium lauryl sulfate) (2.0 parts by mass) in ion-exchanged water (2,900 parts by mass) and the internal temperature was raised to 80° C. with stirring at a stirring rate of 230 rpm under a nitrogen stream.

After a polymerization initiator solution of potassium persulfate (KPS) (10.0 parts by mass) in ion exchanged water (200 parts by mass) was added to the anionic surfactant solution and the internal temperature was controlled to 78° C., a monomer solution (4) composed of:

| | | |
|---|---|---|
| styrene | 548 | parts by mass, |
| 2-ethylhexyl acrylate | 156 | parts by mass, |
| methacrylic acid | 96 | parts by mass, and |
| n-octylmercaptan | 17 | parts by mass |

was added dropwise over 2 hr. After the dropping, the system was heated and stirred over 2 hr at 78° C. to promote polymerization to prepare a dispersion solution of “resin microparticles (C) for a shell layer” containing the resin microparticles (C) for a shell layer dispersed therein. The resin microparticles (C) for a shell layer had a Tg of 53.0° C.

### (2) Preparation of Toner Base Particles (2) (Aggregation, Fusion-Washing-Drying)

A reactor equipped with a stirrer, a temperature sensor, and a condenser tube was charged with the dispersion solution of the “resin microparticles (A) for core” (288 parts by mass as a solid content) and ion-exchanged water (2,000 parts by mass) and an aqueous 5 mol/L sodium hydroxide solution was added so as to adjust the pH of the dispersion solution to 10 (at 25° C.).

Subsequently, the “dispersion solution (1) of colorant microparticles” (40 parts by mass as a solid content) was poured, and then an aqueous solution of magnesium chloride (60 parts by mass) dissolved in ion-exchanged water (60 parts by mass) was added over 10 min at 30° C. under stirring. Then, the resulting mixture was left to stand for 3 min, the system was heated to 80° C. over 60 min, and the particle growth reaction was continued at 80° C. In this state, the size of core particles was measured with “Coulter Multisizer 3” (manufactured by Coulter Beckmann Inc.) and a dispersion solution of the “resin particles (C) for a shell layer” (72 parts by mass as a solid content) was poured over 30 min at the time when the volume-based median diameter (D₅₀) of the core particles reached 6.0 μm, and a solution of sodium chloride (190 parts by mass) in ion-exchanged water (760 parts by mass) was added at the time when a supernatant liquid of the reaction mixture became transparent to stop the growth of the particles. The reaction system was further heated and stirred at 90° C. for allowing the fusion of the particles to proceed. At the time when the average sphericity of the particles measured with an average sphericity measuring device “FPIA-2100” (manufactured by Sysmex Corporation) for toner reached 0.945 (HPF-detected number: 4,000 particles), the reaction system was cooled to 30° C. to give a dispersion solution of “toner base particles (2).”

The dispersion solution of the “toner base particles (2)” was subjected to solid-liquid separation with a centrifugal separator to form wet cake of the toner particles and the cake was washed with ion-exchanged water of 35° C. with the centrifugal separator until the conductivity of the filtrate reached 5 μS/cm. The cake was then transferred to a “Flash Jet Dryer” (manufactured by SEISHIN ENTERPRISE CO., LTD.) and dried into a water content of 0.5 mass % by mass to give “toner base particles (2).”

### (Preparation of Toner (External Additive Treatment))

### (Preparation of Toner 1)

To 100 parts by mass of the toner base particles (1) are added 1.0 part by mass of “monodisperse spherical silica B”, which is a particulate silica of the present invention, (number-average primary particle diameter: 70 nm) and 0.3 parts by mass of a particulate hydrophobic titania (number-average primary particle diameter: 20 nm), and these components were mixed in a Henschel mixer to prepare toner 1.

### (Preparation of Toners 2 to 8)

Toners 2 to 8 were prepared in the same manner as the toner 1 except that toner base particles and monodisperse spherical silica are changed as shown in Table 3.

TABLE 3

| | TONER | EXTERNAL ADDITIVE | |
|---|---|---|---|
| | BASE | | NUMBER-AVERAGE |
| TONER | PARTI- | | PRIMARY PARTICLE |
| NO. | CLES | SILICA PARTICLES | DIAMETER [NM] |
| 1 | [1] | MONODISPERSE | 70 |
| | | SPHERICAL SILICA B | |
| 2 | [1] | MONODISPERSE | 80 |
| | | SPHERICAL SILICA C | |
| 3 | [1] | MONODISPERSE | 100 |
| | | SPHERICAL SILICA D | |
| 4 | [1] | MONODISPERSE | 120 |
| | | SPHERICAL SILICA E | |
| 5 | [1] | MONODISPERSE | 150 |
| | | SPHERICAL SILICA F | |
| 6 | [2] | MONODISPERSE | 80 |
| | | SPHERICAL SILICA C | |
| 7 | [1] | MONODISPERSE | 60 |
| | | SPHERICAL SILICA A | |
| 8 | [1] | MONODISPERSE | 160 |
| | | SPHERICAL SILICA G | |

### (Preparation of Developer)

Into a high-rpm mixer equipped with a horizontal stirring blade were added 100 parts by mass of Mn—Mg “ferrite particles 1” having a volume average diameter of 40 μm and a saturated magnetization of 63 A·m²/kg and 2.0 parts by mass of a copolymer of cyclohexyl methacrylate/methyl methacrylate (mass ratio of monomers=50:50, mass-average molecular weight: 500,000), which were mixed at a peripheral rate of 8 m/sec and at 22° C. for 15 min, and further at 120° C. for 50 min to form a resin covering layer composed of the covering resin on the surfaces of the core particles by the action of mechanical impact force (mechanochemical method), whereby a carrier were prepared.

The carrier thus obtained (93 parts by mass) and each of the toners 1 to 8 (7 parts by mass each) were transferred to a V-shaped mixer and mixed to prepare developers 1 to 8, respectively.

### Examples 1 to 9, Comparative examples 1 to 4

Examples 1 to 9 and Comparative examples 1 to 4 were evaluated by combining the photoreceptors 1 to 9 with the developers 1 to 8.

### (Evaluation Method)

For evaluation of performance, a full-color hybrid machine “bizhub PRO C6501” (manufactured by Konica Minolta Business Technologies Inc.) was used as an evaluation machine, in which the developers 1 to 8 (toners 1 to 8) and each of the photoreceptors 1 to 9 were installed in combination as shown in Table 4 for evaluation.

TABLE 4

| | | | | | | PROTECTIVE LAYER | |
|---|---|---|---|---|---|---|---|
| | | | | | | CONSTITUENTS OF | |
| | | TONER CONSTITUENTS | | | | PHOTORECEPTOR | |
| | | | EXTERNAL ADDITIVE | | | POLYMERIZABLE COMPOUND | |
| | | TONER BASE | | *PARTICLE | | | AMOUNT |
| | TONER | PARTICLES | SILICA | SIZE | PHOTORECEPTOR | EXEMPLARY | (PARTS BY |
| EXAMPLE | NO. | NO. | PARTICLES | [NM] | NO. | COMPOUND NO. | MASS) |
| EXAMPLE 1 | 1 | (1) | B | 70 | 1 | M1 | 100 |
| EXAMPLE 2 | 2 | (1) | C | 80 | 1 | M1 | 100 |
| EXAMPLE 3 | 3 | (1) | D | 100 | 2 | M1 | 100 |
| EXAMPLE 4 | 4 | (1) | E | 120 | 3 | M1 | 100 |
| EXAMPLE 5 | 5 | (1) | F | 150 | 1 | M1 | 100 |
| EXAMPLE 6 | 6 | (2) | C | 80 | 1 | M1 | 100 |
| EXAMPLE 7 | 2 | (1) | C | 80 | 4 | M1 | 100 |
| EXAMPLE 8 | 2 | (1) | C | 80 | 5 | M1 | 100 |
| EXAMPLE 9 | 2 | (1) | C | 80 | 6 | M1 | 100 |
| COMPARATIVE 1 | 7 | (1) | A | 60 | 1 | M1 | 100 |
| COMPARATIVE 1 | 8 | (1) | G | 160 | 7 | M1 | 100 |
| COMPARATIVE 1 | 2 | (1) | C | 80 | 8 | M1 | 100 |
| COMPARATIVE 1 | 2 | (1) | C | 80 | 9 | Z300 | 100 |

| | PROTECTIVE LAYER CONSTITUENTS OF PHOTORECEPTOR | | | | | | |
|---|---|---|---|---|---|---|---|
| | SURFACE-TREATED METAL | | | | | CHARGE | |
| | OXIDE PARTICLES | | | | | TRANSPORT MATERIAL | |
| | | | | SURFACE- | AMOUNT | EXEMPLARY | AMOUNT |
| | | | *PARTICLE | TREATING | (PARTS | COMPOUND | (PARTS |
| EXAMPLE | NO. | TYPE | SIZE [NM] | AGENT | BY MASS) | NO. | BY MASS) |
| EXAMPLE 1 | 1 | TIN OXIDE | 21 | S-15 | 80 | CTM-13 | 25 |
| EXAMPLE 2 | 1 | TIN OXIDE | 21 | S-15 | 80 | CTM-13 | 25 |
| EXAMPLE 3 | 2 | ALUMINA | 30 | S-15 | 200 | CTM-13 | 15 |
| EXAMPLE 4 | 3 | TITANIUM | 6 | S-15 | 100 | CTM-13 | 20 |
| | | OXIDE | | | | | |
| EXAMPLE 5 | 1 | TIN OXIDE | 21 | S-15 | 80 | CTM-13 | 25 |
| EXAMPLE 6 | 1 | TIN OXIDE | 21 | S-15 | 80 | CTM-13 | 25 |
| EXAMPLE 7 | 1 | TIN OXIDE | 21 | S-15 | 80 | CTM-11 | 25 |
| EXAMPLE 8 | 1 | TIN OXIDE | 21 | S-15 | 80 | CTM-5 | 25 |
| EXAMPLE 9 | 1 | TIN OXIDE | 21 | S-15 | 80 | CTM-7 | 25 |
| COMPARATIVE 1 | 1 | TIN OXIDE | 21 | S-15 | 80 | CTM-13 | 25 |
| COMPARATIVE 1 | 1 | TIN OXIDE | 21 | S-15 | 80 | CTM-13 | 20 |
| COMPARATIVE 1 | 1 | TIN OXIDE | 21 | S-15 | 150 | — | — |
| COMPARATIVE 1 | 4 | SILICA | 50 | 1 | 20 | COMPOUND A | 50 |

Z300: POLYCARBONATE RESIN (IUPILON Z300: MANUFACTURED BY MITSUBISHI GAS CHEMICAL CO., INC)
1: HEXAMETHYLDISILAZANE
*PARTICLE SIZE = NUMBER-AVERAGE PRIMARY PARTICLE DIAMETER

After 500,000 prints of a size A4 image with Bk at 2.5% of coverage rate on size A4 neutralized-paper sheets under an ambient condition of 30° C. and 80% R.H. for an image printing endurance test. Evaluations of “transfer efficiency to the intermediate transfer belt from the surface of the photoreceptor”, “surface scratches on the photoreceptor”, and “image blurring” were carried out. The evaluations were made according to the following criteria. The term “transfer efficiency to the intermediate transfer belt from the surface of the photoreceptor” refers to the percentage of the amount of the toner transferred to the transfer belt relative to the amount of the toner developed on the photoreceptor.

The evaluations were carried out based on the following criteria in which ranks A and B were acceptable.

(Transfer Efficiency to Intermediate Transfer Belt from Surface of Photoreceptor)

The transfer efficiency was determined as follows. A copy of a 2 cm by 5 cm solid image was produced to measure the mass of the non-transferred toner remaining on the surface of the photoreceptor and the transferred toner on the intermediate transfer belt, whereby the transfer efficiency was calculated.

Rank A (⊚): 95% or more
Rank B (◯): 90% or more
Rank C (X): 90% or less

### (Image Streak)

The evaluation was carried out after 500,000 prints endurance test under the above ambient condition of 30° C. and 80% R.H. Halftone images were printed to evaluate the streak on the image due to a surface scratch on the photoreceptor. The photoreceptor to be evaluated was placed at the cyan position.

A (⊚): No problems were observed in the halftone image after 500,000 prints (excellent).
B (◯): No streaks were observed, but graininess was observed in the halftone image after 500,000 prints (acceptable in practice).
C (X): Streak due to surface scratch is observed in the halftone image after 500,000 prints (unacceptable in practice).

### (Image Blurring)

The main power source of the machine was powered off immediately after finishing the image printing endurance test of 500,000 sheets under an ambient condition of 30° C. and 80% RH. The power was turned on again after 12 hr and just after reaching to printable mode, a halftone image (0.4 of relative reflection density by a Macbeth densitometer) and a six dot grid pattern image (line width: 0.254 mm, spacing: 10.5 mm) each were printed on the overall surface of size A3 neutralized paper. The state of the printed images was visually observed and evaluated based on the following criteria.

A (⊚): No image blurring was observed in both of the halftone image and the grid pattern image (excellent).
B (◯): A thin strip density decrease was observed only in the halftone image in the longitudinal direction of the photoreceptor (acceptable in practice).
C (X): A deficit or thinning of the line width occurred in a grid pattern image due to image blurring (unacceptable in practice).

TABLE 5

| | TRANSFER | IMAGE | IMAGE |
|---|---|---|---|
| EXAMPLE | EFFICIENCY | STREAKS | BLURRING |
| EXAMPLE 1 | ⊚ | ⊚ | ◯ |
| EXAMPLE 2 | ⊚ | ⊚ | ⊚ |
| EXAMPLE 3 | ⊚ | ◯ | ⊚ |
| EXAMPLE 4 | ⊚ | ◯ | ⊚ |
| EXAMPLE 5 | ⊚ | ◯ | ⊚ |
| EXAMPLE 6 | ⊚ | ⊚ | ◯ |
| EXAMPLE 7 | ⊚ | ⊚ | ◯ |
| EXAMPLE 8 | ⊚ | ◯ | ◯ |
| EXAMPLE 9 | ⊚ | ⊚ | ◯ |
| COMPARATIVE 1 | X | ◯ | X |
| COMPARATIVE 2 | ◯ | X | ◯ |
| COMPARATIVE 3 | ◯ | ◯ | X |
| COMPARATIVE 4 | ◯ | X | ◯ |

The results demonstrate that the use of photoreceptors and developers according to Examples 1 to 9 of the present invention can provide high toner transfer efficiency without image defects caused by scratches on the photoreceptor and image blurring under high-humidity conditions. Comparative examples 1 to 4 are practically unacceptable in at least one of the evaluation items.

### Example 10

Photoreceptor 1 and developer 2 were installed in a full-color hybrid machine “bizhub PRO C6501” and an image of size A4 with a coverage rate of 2.5% was printed on 500,000 A4 neutralized paper sheets for performance evaluation.

The resulting copy images from the first sheet to 500,000th sheet exhibited excellent image quality with high density and low fog, whereby it was confirmed that a combination of the organic photoreceptor and the developer according to the present invention can provide an excellent method for forming an electrophotographic image.

### REFERENCE SIGNS LIST

1. electrically conductive support
2. photosensitive layer
3. intermediate layer
4. charge (carrier) generation layer
5. charge (carrier) transport layer
6. protective layer
7. surface-treated particulate metal oxide
1Y, 1M, 1C, 1Bk photosensitive drums
2Y, 2M, 2C, 2Bk charging unit
3Y, 3M, 3C, 3Bk image exposing unit
4Y, 4M, 4C, 4Bk developing unit
6Y, 6M, 6C, 6Bk cleaning unit
10Y, 10M, 10C, 10Bk image forming unit

1. A method for forming an electrophotographic image using at least an organic photoreceptor, the method comprising: charging, exposing, developing, transferring and cleaning, wherein;
the organic photoreceptor has a photosensitive layer and a protective layer on an electrically conductive support,
the protective layer comprises a resin prepared by polymerization of a polymerizable compound, a particulate metal oxide and a compound represented by a formula (1), and
wherein the developing uses a toner comprising particulate silica having a number-average primary particle diameter of 70 to 150 nm: 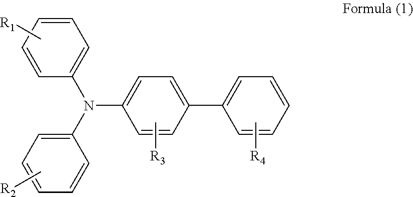
where R₁, R₂, R₃ and R₄ may be same or different and each represents a hydrogen atom or an alkyl group.

2. The method for forming an electrophotographic image according to claim 1, wherein the particulate metal oxide is a particulate tin oxide.

3. The method for forming an electrophotographic image according to claim 1, wherein a diameter of the particulate metal oxide is 3 to 100 nm.

4. The method for forming an electrophotographic image according to claim 1, wherein surface of the particulate metal oxide is treated with a silane coupling agent having a radical polymerizable functional group

5. The method for forming an electrophotographic image according to claim 1, wherein R₁ and R₂ in the formula are different from each other.

6. The method for forming an electrophotographic image according to claim 1, wherein an amount of the compound represented by the formula (1) is 5 to 50 parts by mass relative to 100 parts by mass of the polymerizable compound.

7. The method for forming an electrophotographic image according to claim 1, wherein a polymerization initiator for polymerizing the polymerizable compound is an alkylphenone compound or phosphine oxide compound.

8. The method for forming an electrophotographic image according to claim 7, wherein the polymerization initiator has an acylphosphine oxide structure.

9. The method for forming an electrophotographic image according to claim 1, wherein the toner comprises a styrene-acrylic-modified polyester resin.

10. The method for forming an electrophotographic image according to claim 1, wherein an amount of the particulate silica is 0.7 to 3.0 parts by mass relative to 100 parts by mass of a toner base material.
